(19) United States
(12) Patent Application Publication
(10) Pub. No.: US 2024/0323937 A1
(43) Pub. Date: Sep. 26, 2024

(54) METHOD AND APPARATUS FOR CANCELLATION SEQUENCE IN A WIRELESS COMMUNICATION SYSTEM

(71) Applicant: ASUS Technology Licensing Inc., Taipei City (TW)

(72) Inventor: Ko-Chiang Lin, Taipei City (TW)

(21) Appl. No.: 18/613,964

(22) Filed: Mar. 22, 2024

Related U.S. Application Data
(60) Provisional application No. 63/453,854, filed on Mar. 22, 2023.
(60) Provisional application No. 63/453,858, filed on Mar. 22, 2023.

(51) Int. Cl. H04W 72/0453

(52) U.S. Cl. CPC H04W 72/0453

(57) ABSTRACT

Methods, systems, and apparatuses are provided for cancellation sequence in a wireless communication system, comprising a User Equipment (UE) being configured with or scheduled to perform a first transmission in a first resource and to perform a second transmission in a second resource, wherein the first resource overlaps with the second resource in time domain, not performing the first transmission in the first resource and performing the second transmission in the second resource if the first resource is not within a Uplink (UL) subband and the second resource is within the UL subband, and performing the first transmission in the first resource and not performing the second transmission in the second resource if the first resource is within the UL subband and the second resource is within the UL subband.

### CROSS-REFERENCE TO RELATED APPLICATIONS

The present Application claims priority to and the benefit of U.S. Provisional Patent Application Ser. No. 63/453,854, filed Mar. 22, 2023, and U.S. Provisional Patent Application Ser. No. 63/453,858, filed Mar. 22, 2023; with each of the referenced applications and disclosures fully incorporated herein by reference.

### FIELD

This disclosure generally relates to wireless communication networks and, more particularly, to a method and apparatus for cancellation sequence in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for cancellation sequence in a wireless communication system. In various embodiments, the present invention shows that cancellation sequence considering Subband Full Duplex (SBFD) is more efficient. In various embodiments, the present invention shows that collision handling among multiple beams for duplexing enhancement is more efficient.

In various embodiments, a method of a User Equipment (UE) in a wireless communication system comprises being configured with or scheduled to perform a first transmission in a first resource and to perform a second transmission in a second resource, wherein the first resource overlaps with the second resource in time domain, not performing the first transmission in the first resource and performing the second transmission in the second resource if the first resource is not within a Uplink (UL) subband and the second resource is within the UL subband, and performing the first transmission in the first resource and not performing the second transmission in the second resource if the first resource is within the UL subband and the second resource is within the UL subband.

In various embodiments, a method of a UE in a wireless communication system comprises being configured to perform a Scheduling Request (SR) transmission in a first resource and being configured to perform a Physical Uplink Shared Channel (PUSCH) transmission in a second resource, wherein the first resource overlaps with the second resource in time domain, determining whether to perform the SR transmission and/or the PUSCH transmission based on whether the first resource or the second resource are within a UL subband or not, and determining whether to perform the PUSCH transmission and cancel or suspend the SR transmission after determining whether to perform the first transmission or the second transmission based on whether the first resource or the second resource are within the UL subband or not.

In various embodiments, a method of a UE in a wireless communication system comprises being configured or scheduled to perform a first transmission in a first resource and to perform a second transmission in a second resource, wherein the first resource overlaps with the second resource in time domain, determining whether to perform the first transmission or the second transmission based on whether the first resource or the second resource are within an UL subband or not, and determining whether to multiplex the first transmission into the second transmission or determining whether to perform the first transmission or the second transmission based on a priority of the first transmission and the second transmission after determining whether to perform the first transmission or the second transmission based on whether the first resource or the second resource are within the UL subband or not.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 4.3.1-1: Uplink-downlink timing relation, from 3GPP TS 38.211 V15.7.0, “NR physical channels and modulation.”

FIG. 6 is a flow diagram of a method of a UE in a wireless communication system comprising being scheduled or configured to perform at least two transmissions which comprise at least a first transmission and the second transmission, determining whether to perform or cancel the first transmission or the second transmission based on a first rule, and determining whether to perform or cancel the first transmission or the second transmission based on a second rule after the UE determines whether to perform or cancel the first transmission or the second transmission based on the first rule, in accordance with embodiments of the present invention.

FIG. 7 is a flow diagram of a method of a UE in a wireless communication system comprising being indicated to perform a UL transmission over a set of frequency resource(s), wherein a first part of the set of frequency resource(s) is within a UL subband and a second part of the set of frequency resource(s) is within a DL subband, and determining whether to cancel the UL transmission or perform the UL transmission within the first part of the set of frequency resource(s), in accordance with embodiments of the present invention.

FIG. 8 is a flow diagram of a method of a UE in a wireless communication system comprising being configured with or scheduled to perform a first transmission in a first resource and to perform a second transmission in a second resource, wherein the first resource overlaps with the second resource in time domain, not performing the first transmission in the first resource and performing the second transmission in the second resource if the first resource is not within a UL subband and the second resource is within the UL subband, and performing the first transmission in the first resource and not performing the second transmission in the second resource if the first resource is within the UL subband and the second resource is within the UL subband, in accordance with embodiments of the present invention.

FIG. 9 is a flow diagram of a method of a UE in a wireless communication system comprising being configured to perform an SR transmission in a first resource and being configured to perform a PUSCH transmission in a second resource, wherein the first resource overlaps with the second resource in time domain, determining whether to perform the SR transmission and/or the PUSCH transmission based on whether the first resource or the second resource are within a UL subband or not, and determining whether to perform the PUSCH transmission and cancel or suspend the SR transmission after determining whether to perform the first transmission or the second transmission based on whether the first resource or the second resource are within the UL subband or not, in accordance with embodiments of the present invention.

FIG. 10 is a flow diagram of a method of a UE in a wireless communication system comprising being configured or scheduled to perform a first transmission in a first resource and to perform a second transmission in a second resource, determining whether to perform the first transmission or the second transmission based on whether the first resource or the second resource are within an UL subband or not, and determining whether to multiplex the first transmission into the second transmission or determining whether to perform the first transmission or the second transmission based on a priority of the first transmission and the second transmission after determining whether to perform the first transmission or the second transmission based on whether the first resource or the second resource are within the UL subband or not, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] 3GPP TS 38.211 V15.7.0, “NR physical channels and modulation”; [2] 3GPP TS 38.213 V16.6.0, “NR Physical layer procedures for control”; [3] 3GPP TS 38.321 V16.7.0, “NR MAC protocol specification”; [4] 3GPP TS 38.214 V16.10.0, “NR Physical layer procedures for data”; [5] 3GPP TS 38.213 V17.4.0, “NR Physical layer procedures for control”; [6] 3GPP TS 38.214 V17.4.0, “NR Physical layer procedures for data”; [7] 3GPP TS 38.321 V17.3.0, “NR MAC protocol specification”; [8] RP-212707, “Draft SID on Evolution of NR Duplex Operation”; [9] RAN1 #110 chairman's note; and [10] RAN1 #110bis-e chairman's note. The standards and documents listed above are hereby expressly and fully incorporated herein by reference in their entirety.

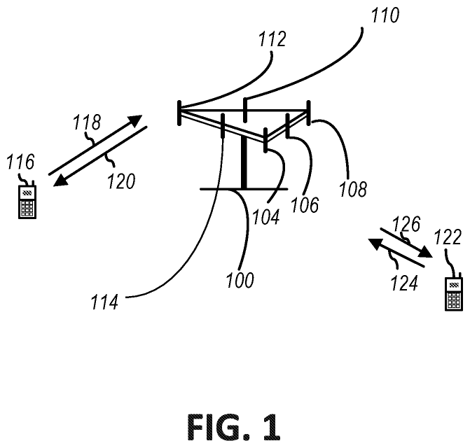

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

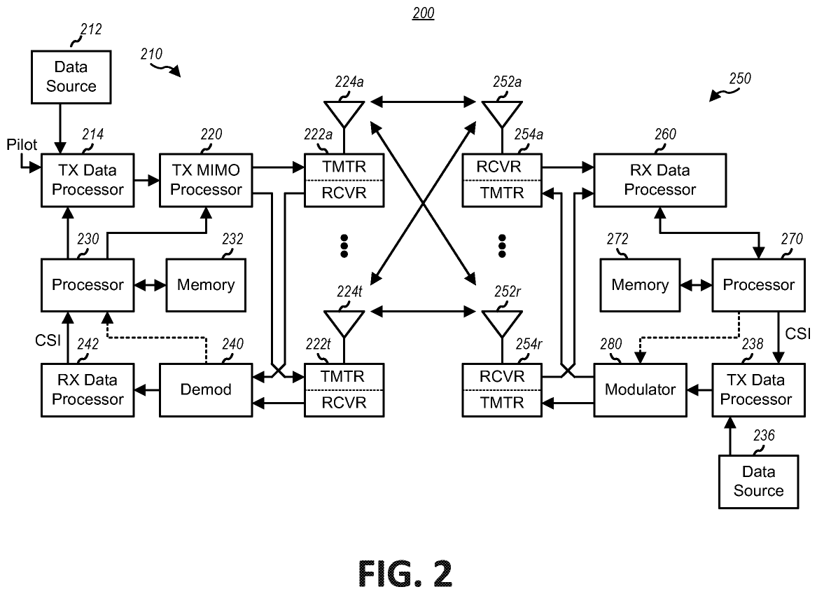

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T}“detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

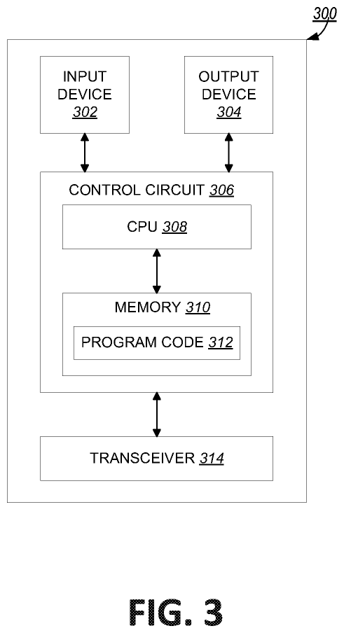

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

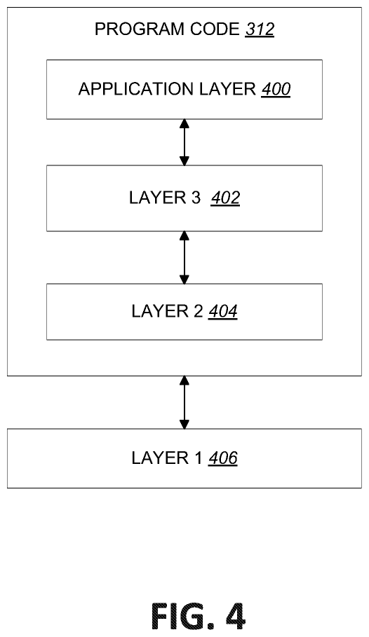

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or NR systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

Frame structure used in New RAT (NR) for 5G, to accommodate various types of requirements for time and frequency resource, more details of NR frame structure, channel, and numerology design is given below from [1] 3GPP TS 38.211 V15.7.0, “NR physical channels and modulation.”

### 4 Frame Structure and Physical Resources

### 4.3 Frame Structure

### 4.3.1 Frames and Subframes

Downlink and uplink transmissions are organized into frames with T_{f}=(ΔfₘₐₓN_{f}/100)·T_{c}=10 ms duration, each consisting of ten subframes of T_{sf}=(ΔfₘₐₓN_{f}/1000)·T_{c}=1 ms duration. The number of consecutive OFDM symbols per subframe is N_{symb}^{subframe,μ}=N_{symb}^{slot}Nₛₗₒₜ^{subframe,μ}. Each frame is divided into two equally-sized half-frames of five subframes each with half-frame 0 consisting of subframes 0-4 and half-frame 1 consisting of subframes 5-9.

There is one set of frames in the uplink and one set of frames in the downlink on a carrier.

Uplink frame number i for transmission from the UE shall start T_{TA}=(N_{TA}+N_{TA,offset})T_{c} before the start of the corresponding downlink frame at the UE where N_{TA,offset} is given by [5, TS 38.213].

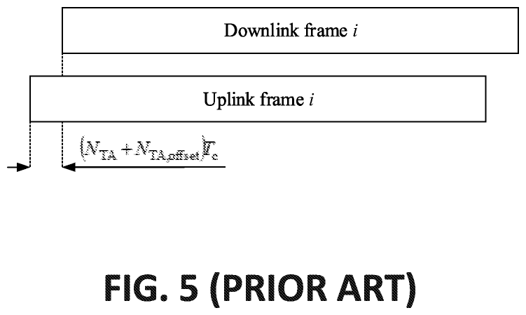

FIG. 5 is a reproduction of FIG. 4.3.1-1: Uplink-downlink timing relation, from 3GPP TS 38.211 V15.7.0, “NR physical channels and modulation.”

### 4.3.2 Slots

For subcarrier spacing configuration μ, slots are numbered nₛ^{μ}ϵ{0, . . . , Nₛₗₒₜ^{subframe,μ}−1} in increasing order within a subframe and n_{s,f}^{μ}ϵ{0, . . . Nₛₗₒₜ^{frame,μ}−1} in increasing order within a frame. There are N_{symb}^{slot} consecutive OFDM symbols in a slot where N_{symb}^{slot} depends on the cyclic prefix as given by Tables 4.3.2-1 and 4.3.2-2. The start of slot nₛ^{μ} in a subframe is aligned in time with the start of OFDM symbol nₛ^{μ}N_{symb}^{slot} in the same subframe.

OFDM symbols in a slot can be classified as ‘downlink’, ‘flexible’, or ‘uplink’. Signaling of slot formats is described in subclause 11.1 of [5, TS 38.213].

In a slot in a downlink frame, the UE shall assume that downlink transmissions only occur in ‘downlink’ or ‘flexible’ symbols.

In a slot in an uplink frame, the UE shall only transmit in ‘uplink’ or ‘flexible’ symbols.

### 4.4 Physical Resources

### 4.4.2 Resource Grid

For each numerology and carrier, a resource grid of N_{grid,x}^{size,μ}N_{sc}^{RB} subcarriers and N_{symb}^{subframe,μ} OFDM symbols is defined, starting at common resource block N_{grid}^{start,μ} indicated by higher-layer signalling. There is one set of resource grids per transmission direction (uplink or downlink) with the subscript x set to DL and UL for downlink and uplink, respectively. When there is no risk for confusion, the subscript x may be dropped. There is one resource grid for a given antenna port p, subcarrier spacing configuration μ, and transmission direction (downlink or uplink).

The carrier bandwidth N_{grid}^{size,μ} for subcarrier spacing configuration μ is given by the higher-layer parameter carrierBandwidth in the SCS-SpecificCarrier IE. The starting position N_{grid}^{start,μ} for subcarrier spacing configuration μ is grid given by the higher-layer parameter offsetToCarrier in the SCS-Specific Carrier IE.

The frequency location of a subcarrier refers to the center frequency of that subcarrier.

For the downlink, the higher-layer parameter txDirectCurrentLocation in the SCS-SpecificCarrier IE indicates the location of the transmitter DC subcarrier in the downlink for each of the numerologies configured in the downlink. Values in the range 0-3299 represent the number of the DC subcarrier and the value 3300 indicates that the DC subcarrier is located outside the resource grid.

For the uplink, the higher-layer parameter txDirectCurrentLocation in the UplinkTxDirectCurrentBWP IE indicates the location of the transmitter DC subcarrier in the uplink for each of the configured bandwidth parts, including whether the DC subcarrier location is offset by 7.5 kHz relative to the center of the indicated subcarrier or not. Values in the range 0-3299 represent the number of the DC subcarrier, the value 3300 indicates that the DC subcarrier is located outside the resource grid, and the value 3301 indicates that the position of the DC subcarrier in the uplink is undetermined.

### 4.4.3 Resource Elements

Each element in the resource grid for antenna port p and subcarrier spacing configuration μ is called a resource element and is uniquely identified by (k, l)_{p,μ} where k is the index in the frequency domain and l refers to the symbol position in the time domain relative to some reference point. Resource element (k, l)_{p,μ} corresponds to a physical resource and the complex value a_{k,l}^{(p,μ)}. When there is no risk for confusion, or no particular antenna port or subcarrier spacing is specified, the indices p and μ may be dropped, resulting in a_{k,l}^{(p)} or a_{k,l}.

### 4.4.4 Resource Blocks

### 4.4.4.1 General

A resource block is defined as N_{sc}^{RB}=12 consecutive subcarriers in the frequency domain.

### 4.4.4.3 Common Resource Blocks

Common resource blocks are numbered from 0 and upwards in the frequency domain for subcarrier spacing configuration μ. The center of subcarrier 0 of common resource block 0 for subcarrier spacing configuration μ coincides with ‘point A’.

The relation between the common resource block number n_{CRB}^{μ} in the frequency domain and resource elements (k, l) for subcarrier spacing configuration μ is given by

$${n}_{CRB}^{μ} = ⌊ \frac{k}{{N}_{sc}^{RB}} ⌋$$

where k is defined relative to point A such that k=0 corresponds to the subcarrier centered around point A.

### 4.4.4.4 Physical Resource Blocks

Physical resource blocks for subcarrier configuration μ are defined within a bandwidth part and numbered from 0 to N_{BWP,i}^{size,μ}−1 where i is the number of the bandwidth part. The relation between the physical resource block n_{PRB}^{μ} in bandwidth part i and the common resource block n_{CRB}^{μ} is given by

$${n}_{CRB}^{μ} = {n}_{PRB}^{μ} + {N}_{BWP , i}^{start , μ}$$

where N_{BWP,i}^{start,μ} is the common resource block where bandwidth part starts relative to common resource block 0. When there is no risk for confusion the index μ may be dropped.

A transmission/reception could be initiated/intended by a UE in response to an indication from a base station (e.g., RRC configuration, DCI, etc.) and/or trigger due to certain events (e.g., data arrival, connection failure, status change, etc.). Normally, a transmission/reception could be performed or conducted accordingly, e.g., on corresponding time and/or frequency resource(s). However, there are also several circumstances or situations or examples under which the (planned or initiated or intended or scheduled) transmission/reception is not performed or is canceled/dropped. For example, when two transmissions collide with each other (e.g., in time and/or frequency domain in a same slot) and a UE is unable to perform both of them, the UE would perform on one of them (e.g. due to priority, property, and/or some other criteria) and drop or cancel the other, e.g., when two PUCCHs or two PUSCHs overlap each other on a same carrier, the UE could transmit one and drop the other. Another situation could be a transmission violates some rules/regulations, e.g., a UL transmission to be performed on a symbol indicated as DL and/or causing a conflict could be canceled (e.g., as quoted above for procedures related to slot format). Also, another case could be a scheduling request overlapping with a PUSCH, wherein the scheduling request could be put on hold and the UE transmits the PUSCH. More details related to cancellation/dropping can be found in the following quotation from [5] 3GPP TS 38.213 V17.4.0, “NR Physical layer procedures for control”; [6] 3GPP TS 38.214 V17.4.0, “NR Physical layer procedures for data”; and [7] 3GPP TS 38.321 V17.3.0, “NR MAC protocol specification”.

A PUSCH or a PUCCH transmission other than PUCCH transmissions with SL HARQ-ACK reports, including repetitions if any, can be of priority index 0 or of priority index 1. For a configured grant PUSCH transmission, a UE determines a priority index from phy-PriorityIndex, if provided. For a PUCCH transmission with HARQ-ACK information corresponding to a SPS PDSCH reception or a SPS PDSCH release, a UE determines a priority index from harq-CodebookID, if provided. For a PUCCH transmission with SR, a UE determines the corresponding priority as described in clause 9.2.4. For a PUSCH transmission with semi-persistent CSI report, a UE determines a priority index from a priority indicator field, if provided, in a DCI format that activates the semi-persistent CSI report. If a priority index is not provided to a UE for a PUSCH or a PUCCH transmission other than PUCCH transmissions with SL HARQ-ACK reports, the priority index is 0.

. . .

If in an active DL BWP a UE monitors PDCCH for detection of DCI format that includes a priority indicator field, a priority index can be provided by the priority indicator field. If a UE indicates a capability to monitor, in an active DL BWP, PDCCH for detection of DCI format that includes a priority indicator field, the DCI format can schedule PUSCH transmissions of any priority, or PDSCH receptions and/or trigger a PUCCH transmission with corresponding HARQ-ACK information of any priority, and DCI format 1_1 or DCI format 1_2 can indicate a TCI state update and trigger a PUCCH transmission with corresponding HARQ-ACK information of any priority.

A DCI format indicating a SPS PDSCH release, or SCell dormancy without scheduling a PDSCH reception, or indicating a TCI state update without scheduling PDSCH reception, is referred to as a DCI format having associated HARQ-ACK information without scheduling a PDSCH reception.

When a UE determines overlapping for PUCCH transmissions with SL HARQ-ACK reports and PUCCH of larger and/or smaller priority index, the UE resolves the overlapping for PUCCH transmissions with SL HARQ-ACK reports and PUCCH of each priority index as described in clause 9.2.5 and 9.2.6 before resolving the overlapping for PUCCH transmissions without SL HARQ-ACK or the overlapping for PUCCH transmissions and PUSCH transmissions.

When a UE determines overlapping for PUCCH and/or PUSCH transmissions of the same priority index other than PUCCH transmissions with SL HARQ-ACK reports before considering limitations for UE transmission as described in clauses 11.1, 11.1.1, and 11.2A including repetitions if any,
first, the UE resolves the overlapping for PUCCHs with repetitions as described in clause 9.2.6, if any
second, the UE resolves the overlapping for PUCCHs without repetitions as described in clauses 9.2.5
third, the UE resolves the overlapping for PUSCHs and PUCCHs with repetitions as described in clause 9.2.6
fourth, the UE resolves the overlapping for PUSCHs and PUCCHs without repetitions as is subsequently described in this clause.

If a UE
is provided simultaneousPUCCH-PUSCH and would transmit a PUCCH with a first priority index and PUSCHs with a second priority index that is different than the first priority index, where the PUCCH and the PUSCHs overlap in time
can simultaneously transmit the PUCCH and the PUSCHs [18, TS 38.306],
   the UE excludes the PUSCHs for resolving the time overlapping between the PUCCH and PUSCHs, where the timeline conditions are not required for the excluded PUSCHs.

When a UE determines overlapping for PUCCH and/or PUSCH transmissions of different priority indexes, other than PUCCH transmissions with SL HARQ-ACK reports, before considering limitations for transmission as described in clauses 11.1, 11.1.1, and 11.2A including repetitions if any, if the UE is provided uci-MuxWithDiffPrio and the timeline conditions in clause 9.2.5 for multiplexing UCI in a PUCCH or a PUSCH are satisfied
first, the UE resolves overlapping for PUCCH and/or PUSCH transmissions of a same priority index as described in clauses 9.2.5 and 9.2.6
second, the UE resolves the overlapping for PUCCH transmissions of different priority indexes, and
   if the UE is provided subslotLengthForPUCCH in the second PUCCH-Config, a PUCCH transmission of smaller priority index is associated with the first overlapping slot with subslotLengthForPUCCH symbols of larger priority index; otherwise, the PUCCH transmission of smaller priority index is associated with the overlapping slot with N_{sym}^{slot} symbols [4, TS 38.211] of larger priority index.
   the UE first resolves the overlapping for PUCCH transmissions, where at least one of the PUCCH transmissions is with N_{PUCCH}^{repeat}>1 repetitions, within a slot of larger priority index as is subsequently described in this clause, if any, and then the UE resolves the overlapping for PUCCH transmissions without repetitions within the slot using the pseudo-code in clause 9.2.5
   if the UE determines that a first PUCCH transmission of the smaller priority index is not dropped and the UCI of the first PUCCH transmission is not multiplexed in a second PUCCH transmission of larger priority index in an overlapping slot with subslotLengthForPUCCH symbols, the first PUCCH transmission is associated with the next overlapping slot with subslotLengthForPUCCH symbols for PUCCH transmissions with the larger priority index
   the UE does not expect a PUCCH transmission that includes UCI of different priority indexes to overlap with a PUCCH transmission with N_{PUCCH}^{repeat}>1 repetitions after resolving the overlapping for PUCCH transmissions without repetitions within a slot
   the UE does not expect a PUCCH transmission with UCI of first and second priority indexes to overlap with a PUCCH transmission with HARQ-ACK information of the first priority index, or with a PUCCH transmission or with a PUSCH transmission of the second priority index when the second priority index is larger than the first priority index
   the UE does not expect a PUCCH transmission with HARQ-ACK information of larger priority index to overlap with more than one PUCCH transmissions with HARQ-ACK information of smaller priority index
third, the UE resolves the overlapping for PUCCH and PUSCH transmissions of different priority indexes
   the UE drops PUSCH transmissions of smaller priority index that overlap with a PUCCH transmission with positive SR of larger priority index prior to multiplexing UCI in a PUSCH transmission of smaller priority index, if any
   the UE drops PUSCH transmissions of smaller priority index that overlap with a PUCCH transmission with N_{PUCCH}^{repeat}>1 repetitions of larger priority index prior to multiplexing UCI in a PUSCH transmission of smaller priority index, if any
   the UE multiplexes HARQ-ACK information in a PUSCH transmission, as is subsequently described in this clause for multiplexing HARQ-ACK information from a PUCCH transmission in a PUSCH transmission of a same priority index, if a PUCCH transmission with HARQ-ACK information of a first priority index overlaps with one or more PUSCH transmissions of a second priority index that is different than the first priority index
if // this is for cases the UE supports multiplexing information of different priorities in a PUCCH/PUSCH transmission
   a PUCCH transmission with HARQ-ACK information, without repetitions, with smaller priority index overlaps with a PUCCH transmission only with HARQ-ACK information, without repetitions, with larger priority index, or
   a PUCCH transmission without repetitions that includes HARQ-ACK information of smaller priority index overlaps with a PUCCH transmission without repetitions using a PUCCH resource with PUCCH format 2/3/4 with HARQ-ACK information and SR of larger priority index, or
   a PUCCH transmission with HARQ-ACK information, without repetitions, with smaller or larger priority index overlaps, respectively, with a PUSCH transmission with larger or smaller priority index
the UE
   multiplexes HARQ-ACK information of different priority indexes and SR information of larger priority index, if any, in a same PUCCH transmission of larger priority index, or multiplexes HARQ-ACK information the UE would provide in a PUCCH transmission of smaller or larger priority index in a PUSCH transmission of larger or smaller priority index, respectively, and applies the procedures in clause 9.2.5.3 or 9.3, respectively, and
   drops CSI and/or SR carried in the PUCCH transmission of smaller priority index, if any
   drops negative SR carried in the PUCCH transmission of larger priority index, if any, if the UE would multiplex the HARQ-ACK information of larger priority index in a PUSCH transmission of smaller priority index
   drops HARQ-ACK information of smaller priority index if the UE would multiplex the HARQ-ACK information of smaller priority index in a PUSCH transmission where the UE multiplexes Part 1 CSI reports and Part 2 CSI reports of larger priority index
   drops Part 2 CSI reports of smaller priority index if the UE would multiplex the HARQ-ACK information of smaller and larger priority indexes in a PUSCH transmission where the UE multiplexes Part 1 CSI reports and Part 2 CSI reports of smaller priority index
   drops HARQ-ACK information of smaller priority index if the UE would multiplex the HARQ-ACK information of smaller priority index in a PUCCH transmission of larger priority index using a PUCCH resource provided by n1PUCCH-AN
   drops Part 2 CSI reports of smaller priority index if the UE would multiplex the HARQ-ACK information of larger priority index in a PUSCH transmission where the UE multiplexes CG-UCI, Part 1 CSI reports and Part 2 CSI reports of smaller priority index
else
   if the UE would transmit the following channels that would overlap in time where, if a channel transmission is with repetitions, the following are applicable per repetition
      a first PUCCH transmission of larger priority index and a second PUCCH transmission of smaller priority index
      a first PUCCH transmission of larger priority index and a second PUSCH transmission of smaller priority index when the UE cannot simultaneously transmit the first PUCCH and second PUSCH
      a first PUCCH transmission of smaller priority index and a second PUSCH transmission of larger priority index when the UE cannot simultaneously transmit the first PUCCH and second PUSCH
   the UE
      transmits the PUCCH or the PUSCH of the larger priority index, and
      does not transmit a PUCCH or a PUSCH of smaller priority index

When a UE determines overlapping for PUCCH and/or PUSCH transmissions of different priority indexes, other than PUCCH transmissions with SL HARQ-ACK reports, before considering limitations for transmissions including with repetitions, if any, as described in clauses 11.1, 11.1.1 and 11.2A, if the UE is not provided uci-MuxWithDiffPrio, the UE first resolves overlapping for PUCCH and/or PUSCH transmissions of smaller priority index as described in clauses 9.2.5 and 9.2.6. Then,
if a transmission of a first PUCCH of larger priority index scheduled by a DCI format in a PDCCH reception would overlap in time with a repetition of a transmission of a second PUSCH or a second PUCCH of smaller priority index, the UE cancels the repetition of a transmission of the second PUSCH or the second PUCCH before the first symbol that would overlap with the first PUCCH transmission
if a transmission of a first PUSCH of larger priority index scheduled by a DCI format in a PDCCH reception would overlap in time with a repetition of the transmission of a second PUCCH of smaller priority index, the UE cancels the repetition of the transmission of the second PUCCH before the first symbol that would overlap with the first PUSCH transmission
   where
the overlapping is applicable before or after resolving overlapping among channels of larger priority index, if any, as described in clauses 9.2.5 and 9.2.6
any remaining PUCCH and/or PUSCH transmission after overlapping resolution is subjected to the limitations for UE transmission as described in clauses 11.1, 11.1.1 and 11.2A
the UE expects that the transmission of the first PUCCH or the first PUSCH, respectively, would not start before T_{proc,2} after a last symbol of the corresponding PDCCH reception
T_{proc,2} is the PUSCH preparation time for a corresponding UE processing capability assuming d_{2,1}=d₁ [6, TS 38.214], based on μ and N₂ as subsequently defined in this clause, and d₁ is determined by a reported UE capability

If a UE is scheduled by a DCI format in a first PDCCH reception to transmit a first PUCCH or a first PUSCH of larger priority index that overlaps with a second PUCCH or a second PUSCH transmission of smaller priority index that, if any, is scheduled by a DCI format in a second PDCCH
T_{proc,2} is based on a value of p corresponding to the smallest SCS configuration of the first PDCCH, the second PDCCHs, the first PUCCH or the first PUSCH, and the second PUCCHs or the second PUSCHs
   if the overlapping group includes the first PUCCH
      if processingType2Enabled of PDSCH-ServingCellConfig is set to enable for the serving cell where the UE receives the first PDCCH and for all serving cells where the UE receives the PDSCHs corresponding to the second PUCCHs, and if processingType2Enabled of PUSCH-ServingCellConfig is set to enable for the serving cells with the second PUSCHs, N₂ is 5 for μ=0, 5.5 for μ=1 and 11 for μ=2
      else, N₂ is 10 for μ=0, 12 for μ=1, 23 for μ=2, 36 for μ=3, 144 for μ=5, and 288 for μ=6;
   if the overlapping group includes the first PUSCH
      if processingType2Enabled of PUSCH-ServingCellConfig is set to enable for the serving cells with the first PUSCH and the second PUSCHs and if processingType2Enabled of PDSCH-ServingCellConfig is set to enable for all serving cells where the UE receives the PDSCHs corresponding to the second PUCCHs, N₂ is 5 for μ=0, 5.5 for μ=1 and 11 for μ=2
      else, N₂ is 10 for μ=0, 12 for μ=1, 23 for μ=2, 36 for μ=3, 144 for μ=5, and 288 for μ=6;

If a PUSCH of larger priority index scheduled by a DCI format overlaps in time with a PUSCH of smaller priority index with SP-CSI report(s) without a corresponding PDCCH in one or more symbols on the same carrier, and if the earliest symbol of these PUSCH channels starts no earlier than N₂+d_{2,1} symbols after the last symbol of the DCI scheduling the PUSCH of larger priority index where d_{2,1} is the maximum of the d_{2,1} associated with PUSCH of larger priority index scheduled by a DCI format and the PUSCH of smaller priority index with SP-CSI report(s) without a corresponding PDCCH, the PUSCH of smaller priority index with SP-CSI report(s) shall not be transmitted by the UE. Otherwise, if the timeline requirement is not satisfied this is an error case.

If a UE would transmit the following channels, including repetitions if any, that would overlap in time
a first PUCCH of larger priority index with SR and a second PUCCH or PUSCH of smaller priority index, or
a configured grant PUSCH of larger priority index and a PUCCH of smaller priority index, or
a first PUCCH of larger priority index with HARQ-ACK information only in response to PDSCH(s) reception without corresponding PDCCH(s) and a second PUCCH of smaller priority index with HARQ-ACK information only in response to PDSCH(s) reception without corresponding PDCCH(s), or a second PUCCH of smaller priority index with SR and/or CSI, or a configured grant PUSCH with smaller priority index, or a PUSCH of smaller priority index with SP-CSI report(s) without a corresponding PDCCH, or
a PUSCH of larger priority index with SP-CSI report(s) without a corresponding PDCCH and a PUCCH of smaller priority index with SR, or CSI, or HARQ-ACK information only in response to PDSCH(s) reception without corresponding PDCCH(s), or
a configured grant PUSCH of larger priority index and a configured grant PUSCH of smaller priority index or a PUSCH of smaller priority index with SP-CSI report(s) without a corresponding PDCCH on a same serving cell
a PUSCH of larger priority index with SP-CSI report(s) without a corresponding PDCCH and a configured grant PUSCH of smaller priority index or a PUSCH of smaller priority index with SP-CSI report(s) without a corresponding PDCCH on a same serving cell
a PUSCH of smaller priority index scheduled by a DCI format and a configured grant PUSCH of larger priority index on a same serving cell if the UE is provided prioLowDG-HighCG
a PUSCH of larger priority index scheduled by a DCI format and a configured grant PUSCH of smaller priority index on a same serving cell if the UE is provided prioHighDG-LowCG
   the UE is expected to cancel a repetition of the PUCCH/PUSCH transmissions of smaller priority index before the first symbol overlapping with the PUCCH/PUSCH transmission of larger priority index if the repetition of the PUCCH/PUSCH transmissions of smaller priority index overlaps in time with the PUCCH/PUSCH transmissions of larger priority index. In case of a PUSCH of larger priority index scheduled by a DCI format in a PDCCH reception and a configured grant PUSCH of smaller priority index on a same serving cell and the UE is provided prioHighDG-LowCG
the UE expects that the transmission of the PUSCH of larger priority index would not start before T_{proc,2} after a last symbol of the corresponding PDCCH reception
T_{proc,2} is the PUSCH preparation time for a corresponding UE processing capability assuming d_{2,1}=d₁+d₃ [6, TS 38.214], based on μ and N₂ as subsequently defined in this clause, and d₁ and d₃ are determined by a reported UE capability

When a UE determines overlapping for PUCCH transmissions with SL HARQ-ACK reports and PUSCH of smaller priority index, including repetitions if any, after resolving the overlapping PUCCH other than PUCCH transmissions with SL HARQ-ACK reports and/or PUSCH transmissions, if the PUSCH includes no UCI, the UE resolves the overlapping for PUCCH transmissions with SL HARQ-ACK reports and PUSCH of smaller priority index as described in clauses 9.2.5 and 9.2.6.

When a UE determines overlapping for PUCCH transmissions with SL HARQ-ACK reports and PUSCH of larger priority index only, including repetitions if any, after resolving the overlapping PUCCH other than PUCCH transmissions with SL HARQ-ACK reports and/or PUSCH transmissions, the UE does not transmit the PUCCH with SL HARQ-ACK reports

where
the UE expects that the transmission of the PUSCH would not start before T_{proc,2}+d₁ after a last symbol of the corresponding PDCCH reception;
T_{proc,2} is the PUSCH preparation time for a corresponding UE processing capability assuming d_{2,1}=0 [6, TS 38.214], based on μ and N₂ as subsequently defined in this clause, and d is determined by a reported UE capability.

In the remaining of this clause, a UE multiplexes UCIs with same priority index in a PUCCH or a PUSCH before considering limitations for UE transmission as described in clauses 11.1, 11.1.1, 11.2A, and 17.2. A PUCCH or a PUSCH is assumed to have a same priority index as a priority index of UCIs a UE multiplexes in the PUCCH or the PUSCH.

In the remaining of this clause, the multiplexing or prioritization for overlapping channels are for overlapping channels with same priority index or for overlapping channels with a PUCCH carrying SL HARQ-ACK information.

If a UE would transmit on a serving cell a PUSCH without UL-SCH that overlaps with a PUCCH transmission on a serving cell that includes positive SR information, the UE does not transmit the PUSCH.

If a UE would transmit CSI reports on overlapping physical channels, the UE applies the priority rules described in [6, TS 38.214] for the multiplexing of CSI reports.

If a UE
would multiplex UCI in a PUCCH transmission that overlaps with a PUSCH transmission, and
the PUSCH and PUCCH transmissions fulfil the conditions in clause 9.2.5 for UCI multiplexing,

### the UE

multiplexes only HARQ-ACK information, if any, from the UCI in the PUSCH transmission and does not transmit the PUCCH if the UE multiplexes aperiodic or semi-persistent CSI reports in the PUSCH;
multiplexes only HARQ-ACK information and CSI reports, if any, from the UCI in the PUSCH transmission and does not transmit the PUCCH if the UE does not multiplex aperiodic or semi-persistent CSI reports in the PUSCH.

If a UE multiplexes aperiodic CSI in a PUSCH and the UE would multiplex UCI that includes HARQ-ACK information in a PUCCH that overlaps with the PUSCH and the timing conditions for overlapping PUCCHs and PUSCHs in clause 9.2.5 are fulfilled, the UE multiplexes only the HARQ-ACK information in the PUSCH and does not transmit the PUCCH.

When a UE transmits multiple PUSCHs on respective serving cells in a slot with reference to slots for PUCCH transmissions and the multiple PUSCHs overlap with a PUCCH carrying UCI in the slot, the UE selects all the PUSCHs overlapping with the PUCCH as the candidate PUSCHs for UCI multiplexing within the slot.

If a UE would transmit a single PUSCH scheduled by a DCI format that includes a DAI field on a serving cell in a slot with reference to slots for PUCCH transmissions without any other PUSCH that would be transmitted on any serving cell in the slot and the UE does not determine any PUCCH carrying HARQ-ACK information in the slot, or if the UE indicates the corresponding capability mux-HARQ-ACK-withoutPUCCH-onPUSCH and the UE transmits multiple PUSCHs on respective serving cells in a slot with reference to slots for PUCCH transmissions and the UE does not determine any PUCCH carrying HARQ-ACK information in the slot and at least one of the multiple PUSCHs is scheduled by a DCI format that includes a DAI field, the UE selects the single PUSCH or all the multiple PUSCHs in the slot as the candidate PUSCHs for HARQ-ACK multiplexing within the slot except for any PUSCH among the multiple PUSCHs that is scheduled by a DCI format that includes a DAI field that is equal to 4 in case the UE is configured with pdsch-HARQ-ACK-Codebook=dynamic or with pdsch-HARQ-ACK-Codebook-r16, or is equal to 0 in case the UE is configured with pdsch-HARQ-ACK-Codebook=semi-static.

The UE determines the PUSCH for UCI multiplexing by applying the following procedure on the candidate PUSCHs as described in this clause:
If the candidate PUSCHs that include first PUSCHs that are scheduled by DCI formats and second PUSCHs configured by respective ConfiguredGrantConfig or semiPersistentOnPUSCH, and the UE would multiplex UCI in one of the candidate PUSCHs, and the candidate PUSCHs fulfil the conditions in clause 9.2.5 for UCI multiplexing, the UE multiplexes the UCI in a PUSCH from the first PUSCHs.
If the UE would multiplex UCI in one of the candidate PUSCHs and the UE does not multiplex aperiodic CSI in any of the candidate PUSCHs, the UE multiplexes the UCI in a PUSCH of the serving cell with the smallest ServCellIndex subject to the conditions in clause 9.2.5 for UCI multiplexing being fulfilled. If the UE transmits more than one PUSCHs in the slot on the serving cell with the smallest ServCellIndex that fulfil the conditions in clause 9.2.5 for UCI multiplexing, the UE multiplexes the UCI in the earliest PUSCH that the UE transmits in the slot.

If a UE transmits a PUSCH over multiple slots or multiple PUSCHs over multiple slots that are scheduled by a DCI format 0_1, and the UE would transmit a PUCCH with HARQ-ACK and/or CSI information over a single slot that overlaps with the PUSCH transmission in one or more slots of the multiple slots, and the PUSCH transmission in the one or more slots fulfills the conditions in clause 9.2.5 for multiplexing the HARQ-ACK and/or CSI information, the UE multiplexes the HARQ-ACK and/or CSI information in the PUSCH transmission in the one or more slots. The UE does not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent.

If a UE transmits a PUSCH with repetition Type B and the UE would transmit a PUCCH with HARQ-ACK and/or CSI information over a single slot that overlaps with the PUSCH transmission in one or more slots, the UE expects all actual repetitions of the PUSCH transmission [6, TS 38.214] that would overlap with the PUCCH transmission to fulfill the conditions in clause 9.2.5 for multiplexing the HARQ-ACK and/or CSI information, and the UE multiplexes the HARQ-ACK and/or CSI information in the earliest actual PUSCH repetition of the PUSCH transmission that would overlap with the PUCCH transmission and includes more than one symbol. The UE does not expect that all actual repetitions that would overlap with the PUCCH transmission do not include more than one symbol.

If the PUSCH transmission over the multiple slots is scheduled by a DCI format that includes a DAI field, the value of the DAI field is applicable for multiplexing HARQ-ACK information in the PUSCH transmission in any slot from the multiple slots where the UE multiplexes HARQ-ACK information.

When a UE would multiplex HARQ-ACK information in a PUSCH transmission that is configured by a ConfiguredGrantConfig, and includes CG-UCI [5, TS 38.212], the UE multiplexes the HARQ-ACK information in the PUSCH transmission if the UE is provided cg-UCI-Multiplexing; otherwise, if the HARQ-ACK information and the PUSCH have same priority index, the UE does not transmit the PUSCH and multiplexes the HARQ-ACK information in a PUCCH transmission or in another PUSCH transmission; if the HARQ-ACK information and the PUSCH have different priority indexes, the UE does not transmit the channel with the smaller priority index.

In the following, DCI formats with CRC scrambled by C-RNTI or CS-RNTI or MCS-C-RNTI are also referred to as unicast DCI formats and DCI formats with CRC scrambled by G-RNTI for multicast or G-CS-RNTI are also referred to as multicast DCI formats. Corresponding unicast DCI formats are DCI formats 0_0/0_1/0_2/1_0/1_1/1_2 and multicast DCI formats are DCI formats 4_1/4_2 [4, TS 38.212]. PDSCH receptions scheduled by unicast or multicast DCI formats or HARQ-ACK information associated with unicast or multicast DCI formats are also respectively referred as unicast or multicast PDSCH receptions or unicast or multicast HARQ-ACK information.

### 9.2.5 UE Procedure for Reporting Multiple UCI Types

This clause is applicable to the case that a UE has resources for PUCCH transmissions or for PUCCH and PUSCH transmissions that overlap in time and each PUCCH transmission is over a single slot without repetitions. Any case that a PUCCH transmission is with repetitions over multiple slots is described in clause 9.2.6. If a UE is configured with multiple PUCCH resources in a slot to transmit CSI reports
if the UE is not provided multi-CSI-PUCCH-ResourceList or if PUCCH resources for transmissions of CSI reports do not overlap in the slot, the UE determines a first resource corresponding to a CSI report with the highest priority [6, TS 38.214]
   if the first resource includes PUCCH format 2, and if there are remaining resources in the slot that do not overlap with the first resource, the UE determines a CSI report with the highest priority, among the CSI reports with corresponding resources from the remaining resources, and a corresponding second resource as an additional resource for CSI reporting
   if the first resource includes PUCCH format 3 or PUCCH format 4, and if there are remaining resources in the slot that include PUCCH format 2 and do not overlap with the first resource, the UE determines a CSI report with the highest priority, among the CSI reports with corresponding resources from the remaining resources, and a corresponding second resource as an additional resource for CSI reporting
if the UE is provided multi-CSI-PUCCH-ResourceList and if any of the multiple PUCCH resources overlap, the UE multiplexes all CSI reports in a resource from the resources provided by multi-CSI-PUCCH-ResourceList, as described in clause 9.2.5.2.

A UE multiplexes DL HARQ-ACK information, with or without SR, and CSI report(s) in a same PUCCH if the UE is provided simultaneousHARQ-ACK-CSI; otherwise, the UE drops the CSI report(s) and includes only DL HARQ-ACK information, with or without SR, in the PUCCH. If the UE would transmit multiple PUCCHs in a slot that include DL HARQ-ACK information and CSI report(s), the UE expects to be provided a same configuration for simultaneousHARQ-ACK-CSI each of PUCCH formats 2, 3, and 4.

If a UE would multiplex CSI reports that include Part 2 CSI reports in a PUCCH resource, the UE determines the PUCCH resource and a number of PRBs for the PUCCH resource or a number of Part 2 CSI reports assuming that each of the CSI reports indicates rank 1, or rank combination of {1, 1} if applicable. If the higher layer parameter csi-ReportMode of CSI reports is set to ‘Mode2’, the UE determines the PUCCH resource and a number of PRBs for the PUCCH resource or a number of Part 2 CSI reports assuming that each CRI in the CSI report is associated with a resource pair.

If a UE would transmit multiple overlapping PUCCHs in a slot or overlapping PUCCH(s) and PUSCH(s) in a slot and, when applicable as described in clauses 9.2.5.1 and 9.2.5.2, the UE is configured to multiplex different UCI types in one PUCCH, and at least one of the multiple overlapping PUCCHs or PUSCHs is in response to a DCI format detection by the UE, the UE multiplexes all corresponding UCI types if the following conditions are met.

If a UE would transmit multiple overlapping PUCCHs in a slot or overlapping PUCCH(s) and PUSCH(s) in a slot, one of the PUCCHs includes HARQ-ACK information in response to an SPS PDSCH reception, and any PUSCH is not in response to a DCI format detection, the UE expects that the first symbol S₀ of the earliest PUCCH or PUSCH satisfies the first of the previous timeline conditions with the exception that components associated to a SCS configuration for a PDCCH scheduling a PDSCH or a PUSCH are absent from the timeline conditions.

If a UE would transmit multiple PUCCHs in a slot that include HARQ-ACK information, and/or SR, and/or CSI reports and any PUCCH with HARQ-ACK information in the slot satisfies the above timing conditions and does not overlap with any other PUCCH or PUSCH in the slot that does not satisfy the above timing conditions, the UE multiplexes the HARQ-ACK information, and/or SR, and/or CSI reports and determines corresponding PUCCH(s) for transmission in the slot according to the following pseudo-code. If the multiple PUCCHs do not include HARQ-ACK information and do not overlap with any PUSCH transmission by the UE in response to a DCI format detection by the UE, the timing conditions do not apply.

If
a UE is not provided multi-CSI-PUCCH-ResourceList, and
a resource for a PUCCH transmission with HARQ-ACK information in response to SPS PDSCH reception and/or a resource for a PUCCH associated with a SR occasion overlap in time with two resources for respective PUCCH transmissions with two CSI reports, and
there is no resource for a PUCCH transmission with HARQ-ACK information in response to a DCI format detection that overlaps in time with any of the previous resources, and
the following pseudo code results to the UE attempting to determine a single PUCCH resource from the HARQ-ACK and/or the SR resource and the two PUCCH resources with CSI reports

### the UE

multiplexes the HARQ-ACK information and/or the SR in the resource for the PUCCH transmission with the CSI report having the higher priority, and
does not transmit the PUCCH with the CSI report having the lower priority

Set Q to the set of resources for transmission of corresponding PUCCHs in a single slot without repetitions where
a resource with earlier first symbol is placed before a resource with later first symbol
for two resources with same first symbol, the resource with longer duration is placed before the resource with shorter duration
for two resources with same first symbol and same duration, the placement is arbitrary
   the above three steps for the set Q are according to a subsequent pseudo-code for a function order(Q)
a resource for negative SR transmission that does not overlap with a resource for HARQ-ACK or CSI transmission is excluded from set Q
if the UE is not provided simultaneousHARQ-ACK-CSI and resources for transmission of HARQ-ACK information include PUCCH format 0 or PUCCH format 2, resources that include PUCCH format 2, or PUCCH format 3, or PUCCH format 4 for transmission of CSI reports are excluded from the set Q if they overlap with any resource from the resources for transmission of HARQ-ACK information
if the UE is not provided simultaneousHARQ-ACK-CSI and at least one of the resources for transmission of HARQ-ACK information includes PUCCH format 1, PUCCH format 3, or PUCCH format 4
   resources that include PUCCH format 3 or PUCCH format 4 for transmission of CSI reports are excluded from the set Q
   resources that include PUCCH format 2 for transmission of CSI reports are excluded from the set Q if they overlap with any resource from the resources for transmission of HARQ-ACK information

### 9.2.5.0 UE Procedure for Prioritization Between SL HARQ-ACK Information in a PUCCH and DL HARQ-ACK or SR or CSI in a PUCCH

The priority value of a PUCCH transmission is as described in clause 16.2.4.3.1.

For prioritization between SL HARQ-ACK information in a first PUCCH and DL HARQ-ACK or SR or CSI in a second PUCCH
if the second PUCCH has priority index 1,
   if sl-PriorityThreshold-UL-URLLC is provided
   the UE transmits the first PUCCH if a smallest priority value of the first PUCCH is smaller than sl-PriorityThreshold-UL-URLLC; otherwise, the UE transmits the second PUCCH
else
   the UE transmits the second PUCCH
else
   the UE transmits the first PUCCH if the smallest priority value of the first PUCCH is smaller than sl-PriorityThreshold; otherwise, the UE transmits the second PUCCH

When the UE determines to transmit the second PUCCH, the UE determines a single resource for multiplexing UCI in the second PUCCH as described in clauses 9.2.5.1 and 9.2.5.2.

### 9.2.5.1 UE Procedure for Multiplexing HARQ-ACK or CSI and SR in a PUCCH

In the following, a UE is configured to transmit K PUCCHs for respective K SRs in a slot, as determined by a set of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, with SR transmission occasions that would overlap with a transmission of a PUCCH with HARQ-ACK information from the UE in the slot or with a transmission of a PUCCH with CSI report(s) from the UE in the slot.

If a UE would transmit a PUCCH with positive SR and at most two HARQ-ACK information bits in a resource using PUCCH format 0, the UE transmits the PUCCH in the resource using PUCCH format 0 in PRB(s) for HARQ-ACK information as described in clause 9.2.3. The UE determines a value of m₀ and m_{CS} for computing a value of cyclic shift a [4, TS 38.211] where m₀ is provided by initialCyclicShift of PUCCH-format0, and m_{CS} is determined from the value of one HARQ-ACK information bit or from the values of two HARQ-ACK information bits as in Table 9.2.5-1 and Table 9.2.5-2, respectively.

If the UE would transmit negative SR and a PUCCH with at most two HARQ-ACK information bits in a resource using PUCCH format 0, the UE transmits the PUCCH in the resource using PUCCH format 0 for HARQ-ACK information as described in clause 9.2.3.

If a UE would transmit SR in a resource using PUCCH format 0 and HARQ-ACK information bits in a resource using PUCCH format 1 in a slot, the UE transmits only a PUCCH with the HARQ-ACK information bits in the resource using PUCCH format 1.

If the UE would transmit positive SR in a first resource using PUCCH format 1 and at most two HARQ-ACK information bits in a second resource using PUCCH format 1 in a slot, the UE transmits a PUCCH with HARQ-ACK information bits in the first resource using PUCCH format 1 as described in clause 9.2.3. If a UE would not transmit a positive SR in a resource using PUCCH format 1 and would transmit at most two HARQ-ACK information bits in a resource using PUCCH format 1 in a slot, the UE transmits a PUCCH in the resource using PUCCH format 1 for HARQ-ACK information as described in clause 9.2.3.

If a UE would transmit a PUCCH with O_{ACK} HARQ-ACK information bits in a resource using PUCCH format 2 or PUCCH format 3 or PUCCH format 4 in a slot, as described in clauses 9.2.1 and 9.2.3, [log₂(K+1)] bits representing a negative or positive SR, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, are appended to the HARQ-ACK information bits and the UE transmits the combined O_{UCI}=O_{ACK}+[log₂ (K+1)] UCI bits in a PUCCH using a resource with PUCCH format 2 or PUCCH format 3 or PUCCH format 4 that the UE determines as described in clauses 9.2.1 and 9.2.3. If one of the SRs is a positive LRR, the value of the [log₂ (K+1)] bits indicates the positive LRR. An all-zero value for the [log₂ (K+1)] bits represents a negative SR value across all K SRs.

If a UE would transmit a PUCCH with O_{CSI} CSI report bits in a resource using PUCCH format 2 or PUCCH format 3 or PUCCH format 4 in a slot, [log₂ (K+1)] bits representing corresponding negative or positive SR, in ascending order of the values of schedulingRequestResourceId, a schedulingRequestResourceId associated with schedulingRequestID-BFR-SCell, a schedulingRequestResourceId associated with schedulingRequestID-BFR, a schedulingRequestResourceId associated with schedulingRequestID-BFR2 if the UE provides twoLRRcapability, and a schedulingRequestResourceId associated with schedulingRequestID-LBT-SCell, are prepended to the CSI information bits as described in clause 9.2.5.2 and the UE transmits a PUCCH with the combined O_{UCI}=[log₂ (K+1)]+O_{CSI} UCI bits in a resource using the PUCCH format 2 or PUCCH format 3 or PUCCH format 4 for CSI reporting. If one of the SRs is a positive LRR, the value of the [log₂ (K+1)] bits indicates the positive LRR. An all-zero value for the [log₂ (K+1)] bits represents a negative SR value across all K SRs.

If a UE transmits a PUCCH with O_{ACK} HARQ-ACK information bits, O_{SR}=[log₂ (K+1)] SR bits, and O_{CRC} CRC bits using PUCCH format 2 or PUCCH format 3 in a PUCCH resource that includes M_{RB}^{PUCCH} PRBs, the UE determines a number of PRBs M_{RB,min}^{PUCCH} for the PUCCH transmission to be the minimum number of PRBs, that is smaller than or equal to a number of PRBs provided by nrofPRBs in PUCCH-format2 or nrofPRBs in PUCCH-format3 and starts from the first PRB from the number of PRBs, that results to (O_{ACK}+O_{SR}+O_{CRC})≤M_{RB,min}^{PUCCH}·N_{sc,ctrl}^{RB}·N_{symb-UCI}^{RB}·N_{symb-UCI}^{PUCCH}·Qₘ·r and, if M_{RB}^{PUCCH}>1, (O_{ACK}+O_{SR}+O_{CRC})>(M_{RB,min}^{PUCCH}−1)·N_{sc,ctrl}^{RB}·N_{symb,UCI}^{PUCCH}·Qₘ·r, where N_{sc,ctrl}^{RB}, N_{symb,UCI}^{PUCCH}, Qₘ, and r are defined in clause 9.2.5.2. For PUCCH format 3, if M_{RB,min}^{PUCCH} is not equal 2^{α}^{₂}·3^{α}^{₃}·5^{α}^{₅} according to [4, TS 38.211], M_{RB,min}^{PUCCH} is increased to the nearest allowed value of nrofPRBs [12, TS 38.331]. If (O_{ACK}+O_{SR}+O_{CRC})>(M_{RB}^{PUCCH}−1)·N_{sc,ctrl}^{RB}·N_{symb,UCI}^{PUCCH}·Qₘ·r, the UE transmits the PUCCH over the M_{RB}^{PUCCH} PRBs.

If a UE is provided a first interlace of M_{Interlace,0}^{PUCCH} PRBs by interlace0 in InterlaceAllocation and transmits a PUCCH with O_{ACK} HARQ-ACK information bits, O_{SR}=[log₂ (K+1)] SR bits, and O_{CRC} CRC bits using PUCCH format 2 or PUCCH format 3, the UE transmits the PUCCH over the first interlace if (O_{ACK}+O_{SR}+O_{CRC})≤M_{Interlace,0}^{PUCCH}·N_{sc,ctrl}^{RB}·N_{symb-UCI}^{PUCCH}·Qₘ·r; otherwise, if the UE is provided a second interlace by interlace1 in PUCCH-format2 or PUCCH-format3, the UE transmits the PUCCH over the first and second interlaces.

### 9.2.5.3 UE Procedure for Reporting UCI of Different Priorities

If a UE
is provided PUCCH-ConfigurationList for PUCCH transmissions with priority 0 and 1,
is provided uci-MuxWithDiffPrio, and
would transmit overlapping PUCCHs that include a first PUCCH with O_{ACK,O} HARQ-ACK information bits of priority 0 and a second PUCCH with O_{ACK,1} HARQ-ACK information bits of priority 1
if the PUCCH resource for the second PUCCH includes PUCCH format 2, 3, or 4 and additionally includes O_{SR,1} SR bits of priority 1, O_{ACK,1} is replaced by O_{ACK,1}+O_{SR,1} where O_{SR,1} is determined according to clause 9.2.5.1

### the UE

determines
   a PUCCH resource set from the second PUCCH-Config using O_{UCI}=O_{ACK,0}+O_{ACK,1} as described in clause 9.2.1, and a PUCCH resource from the PUCCH resource set as described in clause 9.2.3 where a DCI format, if any, triggers PUCCH transmission of priority 1, or
   a PUCCH resource from the second sps-PUCCH-AN-List using O_{UCI}=O_{ACK,0}+O_{ACK,1} as described in clause 9.2.1, and
multiplexes the O_{ACK,0} and O_{ACK,1} HARQ-ACK information bits in a same PUCCH using the PUCCH resource.

If a UE transmits a PUCCH that includes HARQ-ACK information bits of priority 0 and 1 using a PUCCH resource that includes PUCCH format 2, 3 or 4, the UE determines a power for the PUCCH transmission as described in clause 7.2.1 assuming that the PUCCH includes only UCI bits of priority 1, where N_{RE}(i)=min(M_{RB}^{PUCCH}·N_{sc,ctrl}^{RB}·N_{symb-UCI}^{PUCCH}, [(O_{ACK,1}+O_{CRC,1}/(Qₘ·r₁)]). If O_{ACK,1}≤11 bits, n_{HARQ-ACK,1}+O_{SR,1} replaces n_{HARQ-ACK}(i)+O_{SR}(i)+O_{CSI}(i) in the Δ_{TF,b,f,c}(i) calculation in clause 7.2.1; otherwise, O_{ACK,1} replaces O_{ACK}(i)+O_{SR}(i)+O_{CSI}(i) in the BPRE(i) calculation in clause 7.2.1.

If a UE transmits a PUCCH that includes one HARQ-ACK information bit of priority 0 and one HARQ-ACK information bit of priority 1
if the PUCCH transmission uses a resource that includes PUCCH format 0, the HARQ-ACK information bits of priority 1 and priority 0 are set as the first and second bits in Table 9.2.3-4, respectively, to derive the m_{CS} of the PUCCH transmission
if the PUCCH transmission uses a resource that includes PUCCH format 1, the HARQ-ACK information bits of priority 1 and priority 0 are the first and second bits, respectively, of the QPSK modulated symbol for the PUCCH transmission

If a UE transmits a PUCCH that includes HARQ-ACK information bits of priority 0 and 1 using PUCCH format 1, the UE determines a power for the PUCCH transmission as described in clause 7.2.1 assuming that all HARQ-ACK information bits have priority 1.

If a PUSCH with a priority index 0 and SRS configured by SRS-Resource are transmitted in the same slot on a serving cell, the UE may only be configured to transmit SRS after the transmission of the PUSCH and the corresponding DM-RS.

If a PUSCH transmission with a priority index 1 or a PUCCH transmission with a priority index 1 would overlap in time with an SRS transmission on a serving cell, the UE does not transmit the SRS in the overlapping symbol(s).

. . .

For the inter-set guard period, the UE does not transmit any other signal on any symbols of the interval if the interval between SRS resource sets is Y symbols.
When both the SRS resource on all of the corresponding symbols prior to the gap and the SRS resource on all of the corresponding symbols after the gap are dropped due to collision handling, the gap period is also dropped with same priority and can be used for UL transmission.

### 5.4.4 Scheduling Request

The Scheduling Request (SR) is used for requesting UL-SCH resources for new transmission.

The MAC entity may be configured with zero, one, or more SR configurations. An SR configuration consists of a set of PUCCH resources for SR across different BWPs and cells. For a logical channel or for SCell beam failure recovery (see clause 5.17) and for consistent LBT failure recovery (see clause 5.21), at most one PUCCH resource for SR is configured per BWP. For a logical channel serving a radio bearer configured with SDT, PUCCH resource for SR is not configured for SDT. For beam failure recovery of BFD-RS set(s) of Serving Cell, up to two PUCCH resources for SR is configured per BWP. For positioning measurement gap activation/deactivation request, a dedicated SR configuration is configured.

Each SR configuration corresponds to one or more logical channels and/or to SCell beam failure recovery and/or to consistent LBT failure recovery and/or to beam failure recovery of a BFD-RS set and/or to positioning measurement gap activation/deactivation request. Each logical channel, SCell beam failure recovery, beam failure recovery of a BFD-RS set and consistent LBT failure recovery, may be mapped to zero or one SR configuration, which is configured by RRC. The SR configuration of the logical channel that triggered a BSR (clause 5.4.5) or the SCell beam failure recovery or the beam failure recovery of a BFD-RS set or the consistent LBT failure recovery (clause 5.21) (if such a configuration exists) or positioning measurement gap activation/deactivation request (clause 5.25) is considered as corresponding SR configuration for the triggered SR. Any SR configuration may be used for an SR triggered by Pre-emptive BSR (clause 5.4.7) or Timing Advance reporting (clause 5.4.8).

RRC configures the following parameters for the scheduling request procedure:
sr-ProhibitTimer (per SR configuration);
sr-TransMax (per SR configuration).

The following UE variables are used for the scheduling request procedure:
SR_COUNTER (per SR configuration).

If an SR is triggered and there are no other SRs pending corresponding to the same SR configuration, the MAC entity shall set the SR_COUNTER of the corresponding SR configuration to 0.

When an SR is triggered, it shall be considered as pending until it is cancelled.

All pending SR(s) for BSR triggered according to the BSR procedure (clause 5.4.5) prior to the MAC PDU assembly shall be cancelled and each respective sr-ProhibitTimer shall be stopped when the MAC PDU is transmitted and this PDU includes a Long or Short BSR MAC CE which contains buffer status up to (and including) the last event that triggered a BSR (see clause 5.4.5) prior to the MAC PDU assembly. All pending SR(s) for BSR triggered according to the BSR procedure (clause 5.4.5) shall be cancelled and each respective sr-ProhibitTimer shall be stopped when the UL grant(s) can accommodate all pending data available for transmission.

The MAC entity shall for each pending SR not triggered according to the BSR procedure (clause 5.4.5) for a Serving Cell:
1> if this SR was triggered by Pre-emptive BSR procedure (see clause 5.4.7) prior to the MAC PDU assembly and a MAC PDU containing the relevant Pre-emptive BSR MAC CE is transmitted; or
1> if this SR was triggered by beam failure recovery (see clause 5.17) of an SCell and a MAC PDU is transmitted and this PDU includes a MAC CE for BFR which contains beam failure recovery information for this SCell; or
1> if this SR was triggered by beam failure recovery (see clause 5.17) for a BFD-RS set of a Serving Cell and a MAC PDU is transmitted and this PDU includes an Enhanced BFR MAC CE or a Truncated Enhanced BFR MAC CE which contains beam failure recovery information for this BFD-RS set of the Serving Cell; or
1> if this SR was triggered by beam failure recovery (see clause 5.17) of an SCell and this SCell is deactivated (see clause 5.9); or
1> if this SR was triggered by beam failure recovery (see clause 5.17) for a BFD-RS set of an SCell and this SCell is deactivated (see clause 5.9); or
1> if the SR is triggered by positioning measurement gap activation/deactivation request (see clause 5.25) and the Positioning Measurement Gap Activation/Deactivation Request MAC CE that triggers the SR has already been cancelled; or
1> if this SR was triggered by consistent LBT failure recovery (see clause 5.21) of an SCell and a MAC PDU is transmitted and the MAC PDU includes an LBT failure MAC CE that indicates consistent LBT failure for this SCell; or
1> if this SR was triggered by consistent LBT failure recovery (see clause 5.21) of an SCell and all the triggered consistent LBT failure(s) for this SCell are cancelled; or
1> if this SR was triggered by Timing Advance reporting (see clause 5.4.8) and all the triggered Timing Advance reports are cancelled:
   2> cancel the pending SR and stop the corresponding sr-ProhibitTimer, if running.

Only PUCCH resources on a BWP which is active at the time of SR transmission occasion are considered valid.

As long as at least one SR is pending, the MAC entity shall for each pending SR:
1> if the MAC entity has no valid PUCCH resource configured for the pending SR:
   2> initiate a Random Access procedure (see clause 5.1) on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap:
      3> if the PUCCH resource for the SR transmission occasion overlaps with neither a UL-SCH resource whose simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCH-Groups nor an SL-SCH resource; or
      3> if the MAC entity is able to perform this SR transmission simultaneously with the transmission of the SL-SCH resource; or
      3> if the MAC entity is configured with lch-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH or simultaneousPUCCH-PUSCH-SecondaryPUCCHgroup or simultaneousSR-PUSCH-diffPUCCHgroups, and the priority of the uplink grant is determined as specified in clause 5.4.1; or
      3> if both sl-PrioritizationThres and ul-PrioritizationThres are configured and the PUCCH resource for the SR transmission occasion for the pending SR triggered as specified in clause 5.22.1.5 overlaps with any UL-SCH resource(s) carrying a MAC PDU, and the value of the priority of the triggered SR determined as specified in clause 5.22.1.5 is lower than sl-PrioritizationThres and the value of the highest priority of the logical channel(s) in the MAC PDU is higher than or equal to ul-PrioritizationThres and any MAC CE prioritized as described in clause 5.4.3.1.3 is not included in the MAC PDU and the MAC PDU is not prioritized by upper layer according to TS 23.287 [19]; or
      3> if an SL-SCH resource overlaps with the PUCCH resource for the SR transmission occasion for the pending SR triggered as specified in clause 5.4.5, and the MAC entity is not able to perform this SR transmission simultaneously with the transmission of the SL-SCH resource, and either transmission on the SL-SCH resource is not prioritized as described in clause 5.22.1.3.1a or the priority value of the logical channel that triggered SR is lower than ul-PrioritizationThres, if configured; or
      3> if an SL-SCH resource overlaps with the PUCCH resource for the SR transmission occasion for the pending SR triggered as specified in clause 5.22.1.5, and the MAC entity is not able to perform this SR transmission simultaneously with the transmission of the SL-SCH resource, and the priority of the triggered SR determined as specified in clause 5.22.1.5 is higher than the priority of the MAC PDU determined as specified in clause 5.22.1.3.1a for the SL-SCH resource:
         4> consider the SR transmission as a prioritized SR transmission.
         4> consider the other overlapping uplink grant(s), if any, as a de-prioritized uplink grant(s), except for the overlapping uplink grant(s) whose simultaneous transmission is allowed by configuration of simultaneousPUCCH-PUSCH or simultaneousPUCCH-PUSCH-SecondaryPUCCHgroup or simultaneousSR-PUSCH-diffPUCCH-Groups;
         4> if the de-prioritized uplink grant(s) is a configured uplink grant configured with autonomousTx whose PUSCH has already started:
         5> stop the configuredGrantTimer for the corresponding HARQ process of the de-prioritized uplink grant(s);
         5> stop the cg-RetransmissionTimer for the corresponding HARQ process of the de-prioritized uplink grant(s).
         4> if SR_COUNTER<sr-TransMax:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         5> else if lbt-FailureRecoveryConfig is not configured:
         6> increment SR_COUNTER by 1.
         4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> initiate a Random Access procedure (see clause 5.1) on the SpCell and cancel all pending SRs.
      3> else:
         4> consider the SR transmission as a de-prioritized SR transmission.

Duplexing enhancement has been discussed in 3GPP to enable more frequent UL to improve latency and UL coverage. UL transmission and DL transmission could occur on a same symbol for unpaired spectrum (e.g., Time Division Duplex (TDD)). More details regarding duplexing could be found from the quotations below from [8] RP-212707, “Draft SID on Evolution of NR Duplex Operation”; [9] RAN1 #110 chairman's note; and [10] RAN1 #110bis-e chairman's note.

### 4 Objective

### 4.1 Objective of SI

The objective of this study is to identify and evaluate the potential enhancements to support duplex evolution for NR TDD in unpaired spectrum.

In this study, the followings are assumed:
Duplex enhancement at the gNB side
Half duplex operation at the UE side
No restriction on frequency ranges

The detailed objectives are as follows:
Identify applicable and relevant deployment scenarios and use cases (RAN1).
Develop evaluation methodology for duplex enhancement (RAN1).
Study the subband non-overlapping full duplex and potential enhancements on dynamic/flexible TDD.
   Identify possible schemes and evaluate their feasibility and performances (RAN1).
   Study inter-gNB and inter-UE CLI handling and identify solutions to manage them (RAN1).
      Study their impacts on inter-gNB interfaces if needed (RAN3).
      Consider intra-subband CLI and inter-subband CLI in case of the subband non-overlapping full duplex.
   Study the performance of the identified schemes as well as the impact on legacy operation assuming their co-existence in co-channel and adjacent channels (RAN1).
   Study the impact on RF requirements considering the self-interference, the inter-subband CLI, and the inter-operator CLI at gNB and the inter-subband CLI and inter-operator CLI at UE (RAN4).
   Study the impact on RF requirements considering adjacent-channel co-existence with the legacy operation (RAN4).
   RAN4 should be involved early to provide necessary information to RAN1 as needed and to study the feasibility aspects due to high impact in antenna/RF and algorithm design, which include antenna isolation, TX IM suppression in the RX part, filtering and digital interference suppression.
Summarize the regulatory aspects that have to be considered for deploying the identified duplex enhancements in TDD unpaired spectrum (RAN4).

Note: For potential enhancements on dynamic/flexible TDD, utilize the outcome of discussion in Rel-15 and Rel-16 while avoiding the repetition of the same discussion.

### Agreement

Study the following alternatives with Alt 4 prioritized, for SBFD operation at least for RRC_CONNECTED state.
SBFD operation Alt 1:
   Time and frequency locations of subbands for SBFD operation are not known to UEs.
   UE behaviors follow existing specifications without introducing new UE behaviors for SBFD operation at gNB side.
SBFD operation Alt 2:
   Time and frequency locations of subbands for SBFD operation are not known to UEs.
   UE behaviors for non-SBFD aware UEs follow existing specifications.
   From RAN1 perspective, new UE behaviors can be introduced for SBFD aware UEs
SBFD operation Alt 3:
   Only time location of subbands for SBFD operation is known to SBFD aware UEs.
   UE behaviors for non-SBFD aware UEs follow existing specifications.
   From RAN1 perspective, new UE behaviors can be introduced for SBFD aware UEs based on the time location of subbands for SBFD operation
SBFD operation Alt 4:
   Both time and frequency locations of subbands for SBFD operation are known to SBFD aware UEs.
   UE behaviors for non-SBFD aware UEs follow existing specifications.
   From RAN1 perspective, new UE behaviors can be introduced for SBFD aware UEs based on the time and frequency locations of subbands for SBFD operation.

UE capability discussion is held in work item phase.

### Agreement

For indication of subband locations for SBFD operation, study semi-static configuration of subband time and frequency location as baseline.

### Agreement

For semi-static configuration of subband location, consider same subband frequency resources across different SBFD symbols as baseline.

### Working Assumption

For SBFD operation within a TDD carrier, study SBFD scheme within a single configured DL and UL BWP pair with aligned center frequencies as baseline.
FFS feasibility and potential benefit of SBFD scheme within a single configured DL and UL BWP pair with unaligned center frequencies
FFS feasibility and potential benefit of SBFD scheme with more than one configured DL and UL BWP pair with aligned/unaligned center frequencies for a DL and UL BWP pair

### Agreement

For SBFD operation Alt 4, for an SBFD aware UE configured with an UL subband in an SBFD symbol, study the following options:
Option 1: The SBFD aware UE does not expect to be scheduled with UL transmission outside the UL subband or to be scheduled with DL reception within the UL subband in the SBFD symbol
Option 2: The SBFD aware UE does not expect to be scheduled with UL transmission outside the UL subband and may be scheduled with DL reception within the UL subband in the SBFD symbol
Option 3: The SBFD aware UE does not expect to be scheduled with DL reception within the UL subband and may be scheduled with UL transmission outside the UL subband in the SBFD symbol
Option 4: The SBFD aware UE may be scheduled with UL transmission outside the UL subband or DL reception within the UL subband in the SBFD symbol

### Agreement

Study the feasibility and potential benefit of UE-to-UE co-channel CLI measurement and reporting, which can be specific for SBFD, at least includes:
Measurement resource/reporting configuration
Measurement/reporting details (including UE processing delay)
Relevant information exchange (between gNBs) if needed
Usage of measurement at gNB

Note: other enhancement(s) for gNB-to-gNB and UE-to-UE CLI handling specific for SBFD are not precluded.

### Agreement

For SBFD operation at least for RRC_CONNECTED state, it is agreed that SBFD operation Alt 4 is the baseline.
SBFD operation Alt 4:
   Both time and frequency locations of subbands for SBFD operation are known to SBFD aware UEs.
   UE behaviors for non-SBFD aware UEs follow existing specifications.
   From RAN1 perspective, new UE behaviors can be introduced for SBFD aware UEs based on the time and frequency locations of subbands for SBFD operation.

### Agreement

For semi-static configuration of subband frequency locations for SBFD operation, at least explicit indication of frequency location of UL subband is required.
FFS: Whether frequency location of other subbands types is explicitly indicated or implicitly determined.

### Agreement

Study impact and potential enhancements of CSI-RS resource set frequency domain resource allocation and CSI reporting configuration across non-contiguous DL subbands.

### Agreement

Identify if there are any cases of time domain conflict of UE's UL and DL operation in the same SBFD symbol for SBFD aware UE
If there are, whether/how to avoid/handle such collision cases (as second step)

### Agreement

Study impact/potential enhancements for UE-to-UE CLI-RSSI measurement/report considering non-contiguous measurement resource in frequency.

### Agreement

Study whether SBFD operation in SSB symbols is supported or not.

### Agreement

For SBFD operation within a TDD carrier, it is agreed that SBFD scheme within a single configured DL and UL BWP pair with aligned center frequencies is the baseline.

### Agreement

The maximum number of UL subbands for SBFD operation in an SBFD symbol (excluding legacy UL symbol) within a TDD carrier is one for the study in RAN1.
The UL subband can be located at one side of the carrier.
The UL subband can be located at the middle part of the carrier, subject to RAN4's study and conclusion

Note: RAN1 considers the above two possibilities unless RAN4 concludes that any one is infeasible. Note: Two UL subbands for SBFD operation in an SBFD symbol within a TDD carrier due to SBFD operation in legacy UL symbols is subject to further RAN1 discussions which is 2^{nd} priority as per RAN guidance. Send an LS to RAN4 to inform the above agreement. If RAN4 has response, it will be taken into account but in the meanwhile, RAN1 work will continue based on the above.

LS on maximum number of UL subbands for duplex evolution to RAN4 is endorsed. Final LS in R1-2210671.

### Agreement

For semi-static configuration of subband time locations for SBFD operation, it is agreed that explicit configuration of SBFD subband time locations within a period is the baseline.

### Agreement

For a SBFD aware UE semi-statically configured with UL subband in a SBFD symbol configured as DL in TDD-UL-DL-ConfigCommon, the following is agreed as baseline in the RAN1 study:
UL transmissions within UL subband are allowed in the symbol
UL transmissions outside UL subband are not allowed in the symbol
Frequency locations of DL subband(s) are known to the SBFD aware UE
   The frequency location of DL subband(s) can be explicitly indicated or implicitly derived
DL receptions within DL subband(s) are allowed in the symbol
Note: UL transmissions are within active UL BWP and DL receptions are within active DL BWP in the symbol

### Agreement

For the purpose of RAN1 study, the understanding is that for semi-static configuration of subband frequency locations for SBFD operation, frequency location of UL/DL subband is with reference to CRB grid.

R1-2212734 Summary #2 of subband non-overlapping full duplex Moderator (CATT)

### Agreement

Study impact and potential enhancements for UL transmissions and DL receptions across SBFD symbols and non-SBFD symbols, including at least the following:
PDCCH, scheduled/configured PUCCH/PUSCH/PDSCH, without repetition in SBFD symbols and non-SBFD symbols
Scheduled/configured SRS/CSI-RS in SBFD symbols and non-SBFD symbols
Scheduled/configured TBoMS across SBFD symbols and non-SBFD symbols with or without repetition
Multi-PUSCH/PDSCH scheduled by a single DCI in SBFD symbols and non-SBFD symbols
Scheduled/configured PDSCH/PUSCH/PUCCH with repetitions across SBFD symbols and non-SBFD symbols

Note: Inter-slot/intra-slot/inter-repetition/inter-group frequency hopping with DMRS bundling of PUSCH/PUCCH, if applicable, is considered.

Examples of potential enhancements include:
Resource allocation in frequency domain including frequency hopping
Resource allocation in time domain
Power domain
Spatial domain

FFS: If the PUCCH/PUSCH/PDSCH/PDCCH can be mapped to SBFD and non-SBFD in the same slot if configured.

R1-2212735 Summary #3 of subband non-overlapping full duplex Moderator (CATT)

### Agreement

For SBFD operation in a symbol configured as flexible in TDD-UL-DL-Config Common, study the following options for SBFD aware UEs,

### Option 1:

UL transmissions within UL subband are allowed in the symbol
UL transmissions outside UL subband are not allowed in the symbol
Frequency locations of DL subband(s) are known to the SBFD aware UE
DL receptions within DL subband(s) are allowed in the symbol
FFS: Whether DL receptions outside DL subband(s) are allowed or not in the symbol

### Option 2:

UL transmissions within UL subband are allowed in the symbol
The RBs outside the UL subband can be used as either UL, or DL excluding guardband(s) if used, in the symbol from gNB's perspective, and the transmission direction for all those RBs is the same
   FFS: SBFD aware UE behaviours
   FFS: Whether or not signalling of guardband(s) is needed
FFS: Whether or not the symbol can be converted to a DL-only symbol
Frequency locations of DL subband(s) are known to the SBFD aware UE
DL receptions within DL subband(s) are allowed in the symbol

Note: UL transmissions are within active UL BWP and DL receptions are within active DL BWP in the symbol for both options. For all RBs outside the UL subband, UE cannot use separate RBs for DL and UL simultaneously

### Agreement

Study the impact and benefits of potential enhancements to resource allocation in frequency-domain for SBFD operation, considering unaligned boundaries between resource block group(s)/reporting subband(s) and SBFD subbands, including at least the following:
RBG for PDSCH RA type 0
CSI reporting configuration
CSI-RS resource configuration
PRG of PDSCH

### Issues and Solutions

As mentioned above, one transmission and/or reception could be cancelled and/or suspended and/or put on-hold and/or not performed due to several reasons. For example, a User Equipment (UE) may be scheduled with two transmissions (e.g., overlapping each other in time domain and/or in one slot) and the UE is able to transmit one of them and drop the other. Determination of which of the two transmissions/receptions is performed (e.g., and the other dropped or suspended) could be based on several factors, e.g., content of the transmission(s)/reception(s), channel/signal used for the transmission(s)/reception(s), priority of the transmission(s)/reception(s), the way to schedule the transmission(s)/reception(s), or based on a predetermined rule. In another example, a UE could determine to cancel a transmission and/or reception based on slot format. A UE could cancel a transmission on a symbol if/when the symbol is indicated as Downlink (DL). With the introduction of subband non-overlapping full duplex, some extra dropping and/or cancellation is introduced. For example, frequency resource(s) of a transmission could be outside a Uplink (UL) subband and/or within a DL subband, the transmission could be cancelled. There could be some further design required when more than one cancellation occurs. For example, the UE could be scheduled to perform two transmissions. Based on certain criteria, e.g., priority or other factors/criteria mentioned above or herein, the UE could perform a first transmission and cancel a second transmission. However, the first transmission could be further cancelled by subband Slot Form Indicator (SFI), e.g., the first transmission is outside a UL subband and/or is within a DL subband. Then it would result in both transmissions being cancelled even though the UE is able to perform one of them, e.g., especially if/when the second transmission is within the UL subband.

A concept of the present invention is to use a specific sequence to process one or more (cancellation) rule(s). The UE first determines whether to perform or cancel one or more transmission(s)/reception(s) based on a first rule. The UE first determines whether to perform or cancel one or more transmission(s)/reception(s) based on a first rule instead of a second rule. The UE drops a first transmission/reception based on the first rule. The UE does not drop a second transmission/reception based on the second rule. The UE transmits the second transmission/reception based on the first rule. The UE does not transmit the first transmission/reception based on the second rule. After determination of whether to perform or cancel one or more transmission(s)/reception(s) based on the first rule, the UE may or may not determine whether to perform or cancel one or more transmission(s)/reception(s) based on the second rule. After determination of whether to perform or cancel one or more transmission(s)/reception(s) based on the first rule, the UE further determines whether to perform or cancel one or more transmission(s)/reception(s) based on the second rule if the UE is unable to perform the one or more (left) transmission(s)/reception(s). After determination of whether to perform or cancel one or more transmission(s)/reception(s) based on the first rule, the UE does not determine whether to perform or cancel one or more transmission(s)/reception(s) based on the second rule if the UE is able to perform the one or more (left) transmission(s)/reception(s). Based on the first rule, the UE would cancel or drop the first transmission/reception and perform the second transmission/reception. Based on the second rule, the UE would cancel or drop the second transmission/reception and performs the first transmission/reception. The first rule and/or the second rule could be one or more of the following: conflict to subband SFI, conflict to SFI, priority of transmission, content of transmission/reception, channel/signal type used for transmission/reception, Uplink Control Information (UCI) type, UL grant or DL assignment overridden, Scheduling Request (SR) cancellation due to overlapping with Physical Uplink Shared Channel (PUSCH).

In one embodiment, a UE is scheduled and/or configured to perform or receive a first transmission and/or a second transmission. The UE is unable to perform or receive both the first transmission and/or the second transmission. The UE performs or receives the first transmission on a non-Subband Full Duplex (SBFD) symbol, e.g., a symbol not configured for SBFD. The UE cancels or suspends the second transmission on a non-SBFD symbol, e.g., a symbol not configured for SBFD. The UE performs or receives the second transmission on an SBFD symbol, e.g., a symbol configured for SBFD. The UE cancels or suspends the first transmission on an SBFD symbol, e.g., a symbol configured for SBFD. The UE performs or receives the second transmission on an SBFD symbol, e.g., a symbol configured for SBFD if/when the second transmission is for DL and the first transmission overlaps or is within a DL subband. The UE performs or receives the second transmission on an SBFD symbol, e.g., a symbol configured for SBFD if/when the second transmission is for UL and the first transmission overlaps or is within a UL subband. The UE cancels or suspends the first transmission on an SBFD symbol, e.g., a symbol configured for SBFD if/when the first transmission is for DL and the first transmission overlaps or is within a UL subband. The UE cancels or suspends the first transmission on an SBFD symbol, e.g., a symbol configured for SBFD if/when the first transmission is for UL and the first transmission overlaps or is within a DL subband. The first transmission could be a UL transmission within or overlapping with a DL subband. The first transmission could be a DL transmission within or overlapping with a UL subband. The second transmission could be a UL transmission within or overlapping with a UL subband. The second transmission could be a DL transmission within or overlapping with a DL subband. The first transmission could have a higher priority than the second transmission. The first transmission could be a PUSCH transmission, and the second transmission could be an SR transmission. The first transmission could be a transmission scheduled by a Downlink Control Information (DCI) and the second transmission could be a configured transmission. The first transmission could be a first UCI transmission (e.g., with higher priority) and the second transmission could be a second UCI transmission (e.g., with lower priority). The first transmission could overlap with the second transmission (e.g., in time and/or frequency domain). The first transmission and the second transmission could be in a same slot. Based on a first (cancellation) rule, the UE would cancel the first transmission and perform the second transmission. Based on a second (cancellation) rule, the UE would cancel the second transmission and perform the first transmission, e.g., similar or same as what UE does in a non-SBFD symbol. The second rule could be a legacy cancellation rule (e.g., to determine which transmission is cancelled, e.g., as what is done in the background teachings above). The first rule is for SBFD. The first rule is to examine whether the transmission direction is consistent between subband SFI and the transmission(s). The first transmission is cancelled due to the first rule as it is within or overlaps with a subband with a different transmission direction. The second transmission is performed due to the first rule as it is within or overlaps with a subband with a same transmission direction. The UE first processes the first rule. The UE first determines whether to perform or cancel one or more transmission(s) based on the first rule. If the second transmission and a third transmission (e.g., among the one or more transmission(s)) is to be performed based on the first rule. The UE processes the second rule secondly and/or in the following. The UE further determines whether to perform or cancel the second transmission and/or the third transmission based on the second rule. The UE determines to perform the second transmission and cancel the third transmission based on the second rule. The first rule is applied by the UE first. After applying the first rule and determining to perform or cancel one or more transmission, the UE further applies the second rule. The second rule is applied after the first rule.

Throughout embodiments of the present invention, subband could be replaced by Channel State Information (CSI) subband, subband for CSI, subband for SFI, subband for duplex enhancement, subband for transmission direction, or subband for subband SFI, unless otherwise noted.

Throughout embodiments of the present invention, transmission direction could be one or more of DL, UL, flexible, reserved, blank, and/or sidelink.

Throughout embodiments of the present invention, the invention describes behavior or operation of a single serving cell unless otherwise noted.

Throughout embodiments of the present invention, the invention describes behavior or operation of multiple serving cells unless otherwise noted.

Throughout embodiments of the present invention, the invention describes behavior or operation of a single bandwidth part unless otherwise noted.

Throughout embodiments of the present invention, a base station configures multiple bandwidth parts to the UE unless otherwise noted.

Throughout embodiments of the present invention, a base station configures a single bandwidth part to the UE unless otherwise noted.

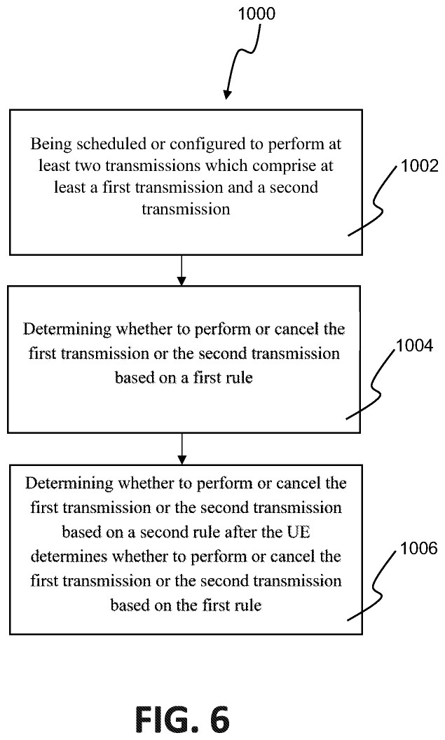

Referring to FIG. 6, with this and other concepts, systems, and methods of the present invention, a method 1000 for a UE in a wireless communication system comprises being scheduled or configured to perform at least two transmissions which comprise at least a first transmission and a second transmission (step 1002), determining whether to perform or cancel the first transmission or the second transmission based on a first rule (step 1004), and determining whether to perform or cancel the first transmission or the second transmission based on a second rule after the UE determines whether to perform or cancel the first transmission or the second transmission based on the first rule (step 1006).

In various embodiments, the first rule is whether the first transmission and/or the second transmission comply with subband SFI of a slot or symbol.

In various embodiments, the first rule is whether the first transmission and/or the second transmission is with a consistent transmission direction.

In various embodiments, the UE cancels the first transmission based on the first rule due to the first transmission is for UL and the first transmission is within a DL subband.

In various embodiments, the UE cancels the first transmission based on the first rule due to the first transmission is for DL and the first transmission is within a UL subband.

In various embodiments, the UE is unable to perform both the first transmission and the second transmission.

In various embodiments, the UE performs the second transmission based on the first rule due to the second transmission is for DL and the first transmission is within a DL subband.

In various embodiments, the UE performs the second transmission based on the first rule due to the second transmission is for UL and the first transmission is within a UL subband.

In various embodiments, the UE would cancel the second transmission and perform the first transmission based on the second rule.

In various embodiments, the first transmission is prioritized over the second transmission based on the second rule.

In various embodiments, the first transmission has a higher priority than that of the second transmission.

In various embodiments, the first transmission is a PUSCH transmission and the second transmission is an SR transmission.

In various embodiments, the first transmission is scheduled by DCI and the second transmission is configured by RRC.

In various embodiments, the first transmission is for a first UCI and the second transmission is for a second UCI.

In various embodiments, the first transmission and the second transmission overlap in time domain.

In various embodiments, the first transmission and the second transmission are in a same slot.

In various embodiments, the UE determines whether to perform or cancel the first transmission or the second transmission based on the first rule when/if the first transmission and the second transmission are within/over an SBFD symbol.

In various embodiments, the UE does not determine whether to perform or cancel the first transmission or the second transmission based on the first rule when/if the first transmission and the second transmission are within/over a non-SFBD symbol.

In various embodiments, the UE determines whether to perform or cancel the first transmission or the second transmission based on the second rule when/if the first transmission and the second transmission are within/over a non-SFBD symbol.

Referring back to FIGS. 3 and 4, in one or more embodiments from the perspective of a UE, the device 300 includes a program code 312 stored in memory 310 of the transmitter. The CPU 308 could execute program code 312 to: (i) be scheduled or configured to perform at least two transmissions which comprise at least a first transmission and the second transmission; (ii) determine whether to perform or cancel the first transmission or the second transmission based on a first rule; and (iii) determine whether to perform or cancel the first transmission or the second transmission based on a second rule after the UE determines whether to perform or cancel the first transmission or the second transmission based on the first rule. Moreover, the CPU 308 can execute the program code 312 to perform all of the described actions, steps, and methods described above, below, or otherwise herein.

### Issues and Solutions

To facilitate UL and DL occurs at the same time (e.g., on one/same symbol and/or at least from a base station perspective) while on different frequency resource(s), UL subband(s) and/or DL subband(s) are introduced. A UE could realize a proper transmission direction based on the information related to a UL subband and/or a DL subband. The UE may detect or determine whether there is conflict for a transmission/reception in terms of transmission direction. For example, the UE is configured or scheduled to perform a UL transmission over a set of frequency resources (e.g., over a set of Physical Resource Blocks (PRBs)). Some of the set of frequency resource(s) could overlap with or be within a UL subband and some of the frequency resource could overlap with or be within a DL subband. Under this situation, e.g., partial overlapping or partial conflict, the UE may be required to determine whether to cancel the whole transmission or to perform part of the transmission (e.g., and cancel another part of transmission) based on some criteria properly.

A first concept of the present invention is to determine whether to cancel a whole transmission or to perform a partial transmission based on the type of the transmission when partial conflict occurs. The UE determines whether to cancel a whole transmission or to perform a partial transmission based on a channel or signal used for the transmission when partial conflict occurs. The UE cancels a whole transmission for Physical Uplink Control Channel (PUCCH) when/if partial conflict occurs for PUCCH transmission. The UE cancels a whole transmission for Physical Downlink Control Channel (PDCCH) when/if partial conflict occurs for PDCCH transmission. The UE cancels a whole transmission for preamble when/if partial conflict occurs for preamble transmission. The UE performs a partial transmission for PUSCH when/if partial conflict occurs for preamble transmission. The UE performs a partial transmission for Physical Downlink Shared Channel (PDSCH) when/if partial conflict occurs for preamble transmission. The UE performs a partial transmission for Sounding Reference Signal (SRS) when/if partial conflict occurs for SRS transmission. The UE cancels a whole transmission for SRS when/if partial conflict occurs for SRS transmission.

A second concept of the present invention is to determine whether to cancel a whole transmission or to perform a partial transmission based on an amount of conflict frequency resource. The UE cancels a whole transmission when/if the amount of conflict frequency resource is more than a threshold (e.g., X PRBs). The UE performs a partial transmission when/if the amount of conflict frequency resource is less than a threshold. The UE cancels a whole transmission when/if a ratio of conflict frequency resource is more than a threshold (e.g., 50%). The UE performs a partial transmission when/if the ratio of conflict frequency resource is less than a threshold (e.g., X PRBs).

When a UE performs partial transmission, the UE performs transmission on frequency resource(s) with consistent transmission direction and cancels or does not perform on frequency resource(s) with inconsistent or conflict transmission direction. When the UE performs partial transmission, the UE performs transmission on frequency resource(s) within a UL subband and cancels or does not perform on other frequency resource(s) within a DL subband.

In one embodiment, a UE is indicated to perform or receive a transmission over a set of frequency resource(s). The set of frequency resource(s) comprise a number of PRBs. A first part of the set of frequency resource(s) (e.g., a first set of PRB(s)) could be within a UL subband. A second part of the set of frequency resource(s) (e.g., a first set of PRB(s)) could be within a DL subband. The transmission could be a UL transmission. A first part of the set of frequency resources could be within a DL subband. A second part of the set of frequency resources could be within a UL subband. The transmission could be a DL transmission. The first part of the set of frequency resources is with a consistent transmission direction. The second part of the set of frequency resources is with an inconsistent or conflicted transmission direction. The UE determines whether to cancel the transmission or perform a transmission over the first part of the set of frequency resource(s) based on a channel or signal carrying the transmission. When/if the UE cancels the transmission, the UE does not perform transmission over the first part of the set of frequency resource(s) and does not perform transmission over the second part of the set of frequency resource(s). When/if the UE performs a transmission over the first part of the set of frequency resource(s), the UE does not perform a transmission over the second part of the set of frequency resource(s) and/or the UE cancels transmission over the second part of the set of frequency resource(s). The UE cancels the transmission if/when the transmission is a PUCCH transmission. The UE cancels the transmission if/when the transmission is a preamble transmission. The UE cancels the transmission if/when the transmission is a PDCCH transmission. The UE cancels the transmission if/when the transmission is an SRS transmission. The UE performs a transmission over the first part of the set of frequency resource(s) if/when the transmission is an SRS transmission. The UE performs a transmission over the first part of the set of frequency resource(s) if/when the transmission is a PUSCH transmission. The UE performs a transmission over the first part of the set of frequency resource(s) if/when the transmission is a PDSCH transmission. The set of frequency resource(s) could be indicated by a DCI. The set of frequency resource(s) could be indicated by a resource allocation field. The set of frequency resource(s) could be configured by Radio Resource Control (RRC).

In another embodiment, a UE is indicated to perform or receive a transmission over a set of frequency resource(s). The set of frequency resource(s) comprise a number of PRBs. A first part of the set of frequency resource(s) (e.g., a first set of PRB(s)) could be within a UL subband. A second part of the set of frequency resource(s) (e.g., a first set of PRB(s)) could be within a DL subband. The transmission could be a UL transmission. A first part of the set of frequency resource could be within a DL subband. A second part of the set of frequency resource could be within a UL subband. The transmission could be a DL transmission. The first part of the set of frequency resources is with consistent transmission direction. The second part of the set of frequency resources is with an inconsistent or conflict transmission direction. The UE determines whether to cancel the transmission or perform a transmission over the first part of the set of frequency resource(s) based on a number of PRB(s) within the first part of the set of frequency resource(s). The UE determines whether to cancel the transmission or perform a transmission over the first part of the set of frequency resource(s) based on a number of PRB(s) within a UL subband. The UE determines whether to cancel the transmission or perform a transmission over the first part of the set of frequency resource(s) based on a number of PRB(s) within a DL subband. When/if the UE cancels the transmission, the UE does not perform transmission over the first part of the set of frequency resource(s) and does not perform transmission over the second part of the set of frequency resource(s). When/if the UE performs a transmission over the first part of the set of frequency resource(s), the UE does not perform a transmission over the second part of the set of frequency resource(s) and/or the UE cancels transmission over the second part of the set of frequency resource(s). The UE cancels the transmission if/when a number of PRB(s) within the first part of the set of frequency resource(s) is more than a threshold. The UE performs a transmission over the first part of the set of frequency resource(s) if/when a number of PRB(s) within the first part of the set of frequency resource(s) is less than a threshold. The threshold could be in a number of PRBs. The threshold could be indicated by a base station to the UE. The UE determines whether to cancel the transmission or perform a transmission over the first part of the set of frequency resource(s) based on a ratio/proportion of PRB(s) within the first part of the set of frequency resource(s). The UE determines whether to cancel the transmission or perform a transmission over the first part of the set of frequency resource(s) based on a ratio/proportion of PRB(s) within a UL subband. The UE determines whether to cancel the transmission or perform a transmission over the first part of the set of frequency resource(s) based on a ratio/proportion of PRB(s) within a DL subband. The UE cancels the transmission if/when a ratio/proportion of PRB(s) within the first part of the set of frequency resource(s) is more than a threshold. The UE performs a transmission over the first part of the set of frequency resource(s) if/when a ratio/proportion of PRB(s) within the first part of the set of frequency resource(s) is less than a threshold. The set of frequency resource(s) could be indicated by a DCI. The set of frequency resource(s) could be indicated by a resource allocation field. The set of frequency resource(s) could be configured by RRC.

Throughout embodiments of the present invention, subband could be replaced by CSI subband, subband for CSI, subband for SFI, subband for duplex enhancement, subband for transmission direction, or subband for subband SFI unless otherwise noted.

Throughout embodiments of the present invention, transmission direction could be one or more of DL, UL, flexible, reserved, blank, and/or sidelink.

Throughout embodiments of the present invention, the invention describes behavior or operation of a single serving cell unless otherwise noted.

Throughout embodiments of the present invention, the invention describes behavior or operation of multiple serving cells unless otherwise noted.

Throughout embodiments of the present invention, the invention describes behavior or operation of a single bandwidth part unless otherwise noted.

Throughout embodiments of the present invention, a base station configures multiple bandwidth parts to the UE unless otherwise noted.

Throughout embodiments of the present invention, a base station configures a single bandwidth part to the UE unless otherwise noted.

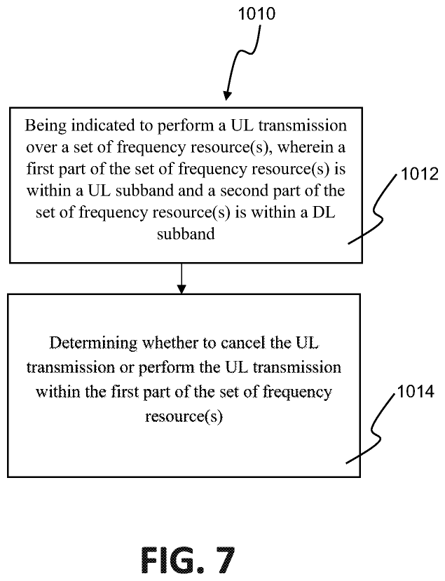

Referring to FIG. 7, with this and other concepts, systems, and methods of the present invention, a method 1010 for a UE in a wireless communication system comprises being indicated to perform a UL transmission over a set of frequency resource(s), wherein a first part of the set of frequency resource(s) is within a UL subband and a second part of the set of frequency resource(s) is within a DL subband (step 1012), and determining whether to cancel the UL transmission or perform the UL transmission within the first part of the set of frequency resource(s) (step 1014).

In various embodiments, the UE determines whether to cancel the UL transmission or perform the UL transmission within the first part of the set of frequency resource(s) based on a channel or signal used for the UL transmission.

In various embodiments, the UE determines whether to cancel the UL transmission or perform the UL transmission within the first part of the set of frequency resource(s) based on a number of PRBs within the UL subband.

In various embodiments, the UE determines whether to cancel the UL transmission or perform the UL transmission within the first part of the set of frequency resource(s) based on a ratio of PRBs within the UL subband.

In various embodiments, the UE cancels the UL transmission if/when the transmission is for PUCCH.

In various embodiments, the UE cancels the UL transmission if/when the transmission is for preamble.

In various embodiments, the UE cancels the UL transmission if/when the transmission is for SRS.

In various embodiments, the UE performs the UL transmission within the first part of the set of frequency resource(s) if/when the transmission is for SRS.

In various embodiments, the UE does not perform the UL transmission within the second part of the set of frequency resource(s) if/when the transmission is for SRS.

In various embodiments, the UE performs the UL transmission within the first part of the set of frequency resource(s) if/when the transmission is for PUSCH.

In various embodiments, the set of frequency resources is indicated by a DCI.

In various embodiments, the set of frequency resources is indicated by a resource allocation field.

In various embodiments, the set of frequency resources is indicated by a bitmap.

In various embodiments, the set of frequency resources is indicated by a Resource Indication Value (RIV).

In various embodiments, the set of frequency resources is indicated by an RRC configuration.

Referring back to FIGS. 3 and 4, in one or more embodiments from the perspective of a UE, the device 300 includes a program code 312 stored in memory 310 of the transmitter. The CPU 308 could execute program code 312 to: (i) be indicated to perform a UL transmission over a set of frequency resource(s), wherein a first part of the set of frequency resource(s) is within a UL subband and a second part of the set of frequency resource(s) is within a DL subband; and (ii) determine whether to cancel the UL transmission or perform the UL transmission within the first part of the set of frequency resource(s). Moreover, the CPU 308 can execute the program code 312 to perform all of the described actions, steps, and methods described above, below, or otherwise herein.

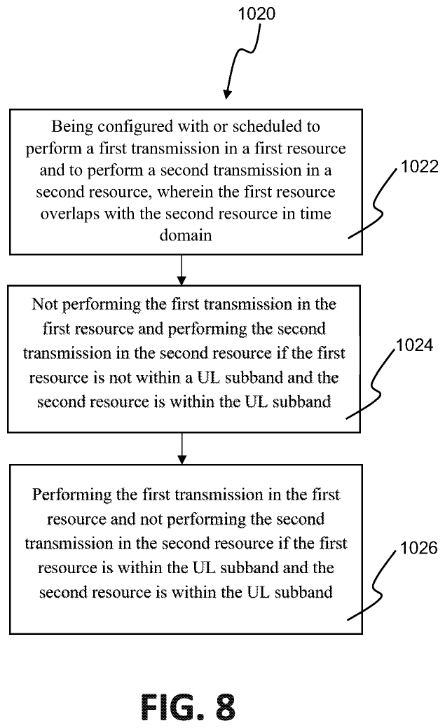

Referring to FIG. 8, with this and other concepts, systems, and methods of the present invention, a method 1020 for a UE in a wireless communication system comprises being configured with or scheduled to perform a first transmission in a first resource and to perform a second transmission in a second resource, wherein the first resource overlaps with the second resource in time domain (step 1022), not performing the first transmission in the first resource and performing the second transmission in the second resource if the first resource is not within a UL subband and the second resource is within the UL subband (step 1024), and performing the first transmission in the first resource and not performing the second transmission in the second resource if the first resource is within the UL subband and the second resource is within the UL subband (step 1026).

In various embodiments, the UE determines whether the second transmission is cancelled due to the first resource overlapping with the second resource after determining whether the first resource and the second resource are within the UL subband or not.

In various embodiments, the first transmission is a first PUSCH transmission.

In various embodiments, the second transmission is a triggered SR transmission.

In various embodiments, the UE determines whether to suspend or cancel the SR transmission after determining whether the first resource and the second resource are within the UL subband or not.

In various embodiments, the second transmission is a PUCCH transmission for CSI and/or a Hybrid Automatic Repeat Request (HARQ)-Acknowledgement (ACK).

In various embodiments, the UE determines whether to multiplex the CSI and/or the HARQ-ACK into the first transmission after determining whether the first resource and the second resource are within the UL subband or not.

In various embodiments, the second transmission is a second PUSCH transmission.

In various embodiments, the UE determines whether to cancel the second PUSCH due to priority after determining whether the first resource and the second resource are within the UL subband or not.

In various embodiments, the UE cancels or postpones the first transmission if the first resource is not within the UL subband and the second resource is within the UL subband.

In various embodiments, the UE cancels the second transmission if the first resource is within the UL subband and the second resource is within the UL subband.

Referring back to FIGS. 3 and 4, in one or more embodiments from the perspective of a UE, the device 300 includes a program code 312 stored in memory 310 of the transmitter. The CPU 308 could execute program code 312 to: (i) be configured with or scheduled to perform a first transmission in a first resource and to perform a second transmission in a second resource, wherein the first resource overlaps with the second resource in time domain; (ii) not perform the first transmission in the first resource and performing the second transmission in the second resource if the first resource is not within a UL subband and the second resource is within the UL subband; and (iii) perform the first transmission in the first resource and not perform the second transmission in the second resource if the first resource is within the UL subband and the second resource is within the UL subband. Moreover, the CPU 308 can execute the program code 312 to perform all of the described actions, steps, and methods described above, below, or otherwise herein.

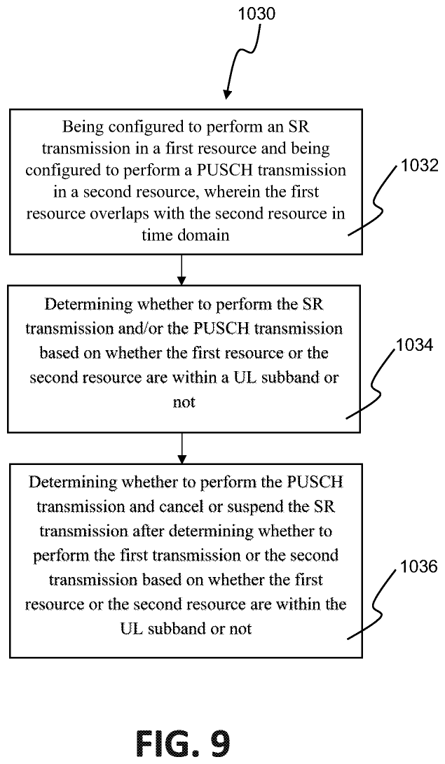

Referring to FIG. 9, with this and other concepts, systems, and methods of the present invention, a method 1030 for a UE in a wireless communication system comprises being configured to perform an SR transmission in a first resource and being configured to perform a PUSCH transmission in a second resource, wherein the first resource overlaps with the second resource in time domain (step 1032), determining whether to perform the SR transmission and/or the PUSCH transmission based on whether the first resource or the second resource are within a UL subband or not (step 1034), and determining whether to perform the PUSCH transmission and cancel or suspend the SR transmission after determining whether to perform the first transmission or the second transmission based on whether the first resource or the second resource are within the UL subband or not (step 1036).

In various embodiments, the UE determines to perform the PUSCH transmission and to cancel or suspend the SR transmission if the first resource and the second resource are within the UL subband.

In various embodiments, the UE cancels the SR transmission if the first resource is within the UL subband and/or cancels the PUSCH transmission if the second resource is within the UL subband.

In various embodiments, the UE performs the SR transmission and cancels the PUSCH transmission if the first resource is within the UL subband and the second resource is not within the UL subband.

Referring back to FIGS. 3 and 4, in one or more embodiments from the perspective of a UE, the device 300 includes a program code 312 stored in memory 310 of the transmitter. The CPU 308 could execute program code 312 to: (i) be configured to perform an SR transmission in a first resource and be configured to perform a PUSCH transmission in a second resource, wherein the first resource overlaps with the second resource in time domain; (ii) determine whether to perform the SR transmission and/or the PUSCH transmission based on whether the first resource or the second resource are within a UL subband or not; and (iii) determine whether to perform the PUSCH transmission and cancel or suspend the SR transmission after determining whether to perform the first transmission or the second transmission based on whether the first resource or the second resource are within the UL subband or not. Moreover, the CPU 308 can execute the program code 312 to perform all of the described actions, steps, and methods described above, below, or otherwise herein.

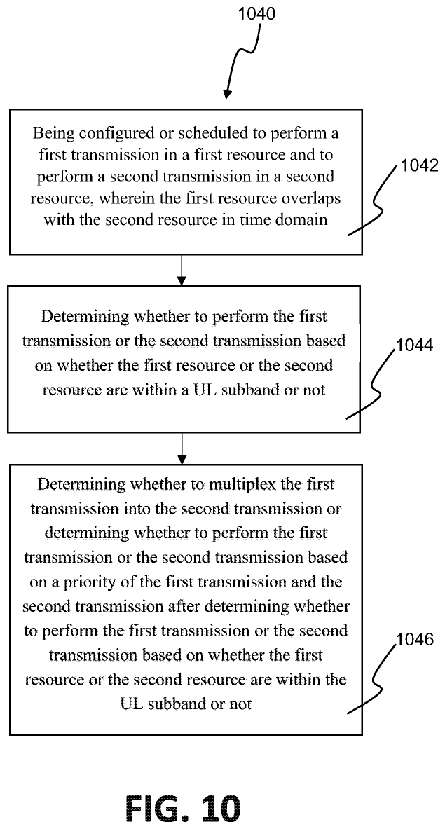

Referring to FIG. 10, with this and other concepts, systems, and methods of the present invention, a method 1040 for a UE in a wireless communication system comprises being configured or scheduled to perform a first transmission in a first resource and to perform a second transmission in a second resource, wherein the first resource overlaps with the second resource in time domain (step 1042), determining whether to perform the first transmission or the second transmission based on whether the first resource or the second resource are within an UL subband or not (step 1044), and determining whether to multiplex the first transmission into the second transmission or determining whether to perform the first transmission or the second transmission based on a priority of the first transmission and the second transmission after determining whether to perform the first transmission or the second transmission based on whether the first resource or the second resource are within the UL subband or not (step 1046).

In various embodiments, the UE multiplexes the first transmission into the second transmission if the first resource and the second resource are within the UL subband.

In various embodiments, the UE does not multiplex the first transmission into the second transmission if the first resource is within the UL subband and the second resource is not within the UL subband.

In various embodiments, the UE performs the second transmission with a higher priority and cancels the first transmission with a lower priority if the first resource and the second resource are within the UL subband.

In various embodiments, the UE performs the first transmission with a lower priority and cancels the second transmission with a higher priority if the first resource is within the UL subband and the second resource is not within the UL subband.

Referring back to FIGS. 3 and 4, in one or more embodiments from the perspective of a UE, the device 300 includes a program code 312 stored in memory 310 of the transmitter. The CPU 308 could execute program code 312 to: (i) be configured or scheduled to perform a first transmission in a first resource and to perform a second transmission in a second resource, wherein the first resource overlaps with the second resource in time domain; (ii) determine whether to perform the first transmission or the second transmission based on whether the first resource or the second resource are within an UL subband or not; and (iii) determine whether to multiplex the first transmission into the second transmission or determine whether to perform the first transmission or the second transmission based on a priority of the first transmission and the second transmission after determining whether to perform the first transmission or the second transmission based on whether the first resource or the second resource are within the UL subband or not. Moreover, the CPU 308 can execute the program code 312 to perform all of the described actions, steps, and methods described above, below, or otherwise herein.

Any combination of the above or herein concepts or teachings can be jointly combined, in whole or in part, or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method of a User Equipment (UE), comprising:
being configured with or scheduled to perform a first transmission in a first resource and to perform a second transmission in a second resource, wherein the first resource overlaps with the second resource in time domain;
not performing the first transmission in the first resource and performing the second transmission in the second resource if the first resource is not within an Uplink (UL) subband and the second resource is within the UL subband; and
performing the first transmission in the first resource and not performing the second transmission in the second resource if the first resource is within the UL subband and the second resource is within the UL subband.

2. The method of claim 1, wherein the UE determines whether the second transmission is cancelled due to the first resource overlapping with the second resource after determining whether the first resource and the second resource are within the UL subband or not.

3. The method of claim 1, wherein the first transmission is a first Physical Uplink Shared Channel (PUSCH) transmission.

4. The method of claim 1, wherein the second transmission is a triggered Scheduling Request (SR) transmission.

5. The method of claim 4, wherein the UE determines whether to suspend or cancel the SR transmission after determining whether the first resource and the second resource are within the UL subband or not.

6. The method of claim 1, wherein the second transmission is a Physical Uplink Control Channel (PUCCH) transmission for Channel State information (CSI) and/or Hybrid Automatic Repeat Request (HARQ)-Acknowledgement (ACK).

7. The method of claim 6, wherein the UE determines whether to multiplex the CSI and/or the HARQ-ACK into the first transmission after determining whether the first resource and the second resource are within the UL subband or not.

8. The method of claim 1, wherein the second transmission is a second PUSCH transmission.

9. The method of claim 8, wherein the UE determines whether to cancel the second PUSCH due to priority after determining whether the first resource and the second resource are within the UL subband or not.

10. The method of claim 1, wherein the UE cancels or postpones the first transmission if the first resource is not within the UL subband and the second resource is within the UL subband.

11. The method of claim 1, wherein the UE cancels the second transmission if the first resource is within the UL subband and the second resource is within the UL subband.

12. A method of a User Equipment (UE), comprising:
being configured to perform a Scheduling Request (SR) transmission in a first resource and being configured to perform a Physical Uplink Shared Channel (PUSCH) transmission in a second resource, wherein the first resource overlaps with the second resource in time domain;
determining whether to perform the SR transmission and/or the PUSCH transmission based on whether the first resource or the second resource are within an Uplink (UL) subband or not; and
determining whether to perform the PUSCH transmission and cancel or suspend the SR transmission after determining whether to perform the first transmission or the second transmission based on whether the first resource or the second resource are within the UL subband or not.

13. The method of claim 12, wherein the UE determines to perform the PUSCH transmission and to cancel or suspend the SR transmission if the first resource and the second resource are within the UL subband.

14. The method of claim 12, wherein the UE cancels the SR transmission if the first resource is within the UL subband and/or cancels the PUSCH transmission if the second resource is within the UL subband.

15. The method of claim 12, wherein the UE performs the SR transmission and cancels the PUSCH transmission if the first resource is within the UL subband and the second resource is not within the UL subband.

16. A method of a User Equipment (UE), comprising:
being configured or scheduled to perform a first transmission in a first resource and to perform a second transmission in a second resource, wherein the first resource overlaps with the second resource in time domain;
determining whether to perform the first transmission or the second transmission based on whether the first resource or the second resource are within an Uplink (UL) subband or not; and
determining whether to multiplex the first transmission into the second transmission or determining whether to perform the first transmission or the second transmission based on a priority of the first transmission and the second transmission after determining whether to perform the first transmission or the second transmission based on whether the first resource or the second resource are within the UL subband or not.

17. The method of claim 16, wherein the UE multiplexes the first transmission into the second transmission if the first resource and the second resource are within the UL subband.

18. The method of claim 16, wherein the UE does not multiplex the first transmission into the second transmission if the first resource is within the UL subband and the second resource is not within the UL subband.

19. The method of claim 16, wherein the UE performs the second transmission with a higher priority and cancels the first transmission with a lower priority if the first resource and the second resource are within the UL subband.

20. The method of claim 16, wherein the UE performs the first transmission with a lower priority and cancels the second transmission with a higher priority if the first resource is within the UL subband and the second resource is not within the UL subband.
